(19) United States
(12) Patent Application Publication
(10) Pub. No.: US 2005/0196626 A1
(43) Pub. Date: Sep. 8, 2005

(54) Photochromic optical article

(76) Inventors: Carol L. Knox, Monroeville, PA (US); James A. Claar, Apollo, PA (US); David N. Walters, Slippery Rock, PA (US); Stephen J. Thomas, Aspinwall, PA (US)

Correspondence Address: Frank P. Mallak, One PPG Place, Pittsburgh, PA, 15272, US

(21) Appl. No.: 10/793,518

(22) Filed: Mar. 4, 2004

(51) Int. Cl. B32B 25/20

(52) U.S. Cl. 428/447

(57) ABSTRACT

Describes a photochromic article, e.g., an ophthalmic photochromic article, such as a plastic lens, in which the article includes (1) a rigid substrate, such as a transparent thermoset or thermoplastic polymeric substrate, (2) a photochromic polymeric coating appended to, at least a portion of at least one surface of the substrate, the photochromic polymeric coating containing a photochromic amount of at least one photochromic material, e.g., spirooxazine, naphthopyran and/or fulgide, and (3) a layer chosen from a second organic polymeric coating or an abrasion resistant coating that is superposed on said photochromic polymeric coating. Describes incorporating at least one polysiloxane surface active agent within the photochromic polymeric coating in amounts sufficient to inhibit migration of the photochromic material, e.g., into said layer superposed on said photochromic polymeric coating. Describes also the aforedescribed photochromic article having an abrasion-resistant coating affixed to the second organic polymeric coating, e.g., an abrasion-resistant coating comprising an organo silane; and a photochromic article having an antireflective coating affixed to the abrasion-resistant coating.

### DESCRIPTION OF THE INVENTION

The present invention relates to photochromic articles comprising a rigid substrate to which is applied a photochromic polymeric coating. In particular, the present invention relates to photochromic articles comprising a rigid transparent substrate, e.g., glass and organic plastic substrates used for optical applications. More particularly, the present invention relates to photochromic articles used for ophthalmic applications, e.g., lenses. Still more particularly, the present invention relates to photochromic articles comprising a transparent organic polymeric substrate having a transparent photochromic organic polymeric coating superposed on at least a portion of at least one surface of the substrate. Further, the transparent photochromic organic polymeric coating comprises a migration inhibiting amount of a polysiloxane surface active agent.

Still further, the present invention relates to the foregoing photochromic article in which an abrasion resistant coating can be superposed on, e.g., appended to, the photochromic polymeric coating, and optionally in which an antireflective coating is superposed on, e.g., appended to, the abrasion resistant coating. In an alternative contemplated embodiment, a second transparent organic polymeric layer that typically is not photochromic is superposed on the exposed surface of said photochromic polymeric coating. The abrasion resistant coating can be superposed on the second transparent polymeric layer, and in turn the antireflective coating can be placed adjacent to the exposed surface of the abrasion resistant coating. The second transparent polymeric layer can be referred to as a tie layer because of its location between the photochromic polymeric coating and the abrasion resistant coating and, because in one contemplated embodiment, it ties together the photochromic polymeric coating and the abrasion resistant coating.

In a particular embodiment, the present invention relates to photochromic articles, such as an ophthalmic plastic lens, on at least a portion of at least one surface of which has been appended sequentially, a first layer of a transparent, desirably optically clear, photochromic polymeric coating, which photochromic coating comprises a polysiloxane surface active agent, and a further layer of either a transparent abrasion resistant coating or a second transparent organic polymer tie layer. In a further embodiment of the present invention, the abrasion resistant coating is appended to the second polymer tie layer. In a still further embodiment of the present invention, there are contemplated photochromic articles having an additional layer comprising an antireflective coating that is applied to the abrasion resistant coating. Also, additional layers can be applied to the antireflective coating or to the abrasion resistant coating in place of or below the antireflective coating to provide additional functional properties to the photochromic article, e.g., antistatic and/or anti-wetting coatings.

Clear ophthalmic articles that provide good imaging qualities while reducing the transmission of incident light into the eye are needed for a variety of applications, such as sunglasses, vision correcting ophthalmic lenses, piano lenses and fashion lenses, e.g., non-prescription and prescription lenses, sport masks, face shields, goggles, visors, camera lenses, windows, automotive windshields, and aircraft and automotive transparencies, e.g., T-roofs, sidelights and backlights. Responsive to that need, photochromic plastic articles used for optical applications have been given considerable attention. In particular, photochromic ophthalmic plastic lenses have been of interest because of the weight advantage they offer, vis-à-vis, glass lenses.

In addition, embodiments of the present invention can be used in association with plastic films and sheets, optical devices, e.g., optical switches, display devices and memory storage devices, such as those described in U.S. Pat. No. 6,589,452, and security elements, such as optically-readable data media, e.g., those described in U.S. Patent Application 2002/0142248, security elements in the form of threads or strips, as described in U.S. Pat. No. 6,474,695, and security elements in the form of verification marks that can be placed on security documents and articles of manufacture.

Photochromism is a phenomenon involving a reversible change in color of an organic or inorganic material, e.g., a chromene or silver halide salt, or an article comprising such a material, upon exposure to ultraviolet radiation. Sources of radiation that contain ultraviolet rays include, for example, sunlight and the light of a mercury lamp. When the photochromic material is exposed to ultraviolet radiation, it exhibits a change in color, and when the ultraviolet radiation is discontinued, the photochromic material returns to its original color or colorless state. Ophthalmic articles that have photochromic material(s) applied to or incorporated within the article exhibit this reversible change in color and a consequent reversible change in light transmission.

The mechanism believed to be responsible for this reversible change in color, e.g., the change in the absorption spectrum in the electromagnetic spectrum of visible light (400-700 nm), that is characteristic of different types of organic photochromic compounds has been described. See, for example, John C. Crano, “Chromogenic Materials (Photochromic)”, Kirk-Othmer Encyclopedia of Chemical Technology, fourth Edition, 1993, pp. 321-332. The mechanism responsible for the reversible change in color for organic photochromic compounds, such as indolino spiropyrans and indolino spirooxazines, is reported to involve an electrocyclic mechanism. When exposed to activating ultraviolet radiation, these organic photochromic compounds transform from a colorless closed ring form into a colored open ring form. In contrast, the electrocyclic mechanism responsible for the reversible change in color of photochromic fulgide compounds is reported to involve a transformation from a colorless open ring form into a colored closed ring form.

Photochromic plastic articles have been prepared by incorporating the photochromic material into the plastic substrate by surface imbibition techniques. In this method, photochromic dyes/compounds are incorporated into the subsurface region of a plastic article, such as a lens, by first applying one or more photochromic dyes/compounds to the surface of the plastic article, either as the neat photochromic dye/compound or dissolved in a polymeric or other organic solvent carrier, and then applying heat to the coated surface to cause the photochromic dye/compound(s) to diffuse into the subsurface region of the plastic article (a process commonly referred to as “imbibition”). The plastic substrates of such photochromic plastic articles are considered to have sufficient free volume within the polymer matrix to allow photochromic compounds, such as the aforementioned spirooxazines, spiropyrans and fulgides, to transform from the colorless form into the colored form, and then revert to their original colorless form. There are, however, certain polymer matrices that are considered not to have sufficient free volume to allow the aforedescribed electrocyclic mechanism to occur sufficiently to permit their use as a substrate for imbibed (or internally incorporated) photochromic materials for commercially acceptable photochromic applications. Such substrates include, for example, thermoset polymer matrices, such as those prepared from polyol (allyl carbonate) monomers such as allyl diglycol carbonate monomers, e.g., diethylene glycol bis(allyl carbonate), and copolymers thereof, the commonly known thermoplastic bisphenol A-based polycarbonates, and highly cross-linked optical polymers.

To allow the use of thermoset polymers, thermoplastic polycarbonates, and highly cross-linked optical polymeric materials as plastic substrates for photochromic articles, it has been proposed to apply organic photochromic coatings to the surface of such plastic substrates. It has also been proposed to apply an abrasion-resistant coating onto the exposed surface of the photochromic coating to protect the surface of the photochromic coating from scratches and other similar cosmetic defects resulting from physical handling, cleaning and exposure of the photochromic coating to the environment.

In certain circumstances involving ophthalmic plastic lenses having a photochromic polymeric coating, it has been observed that the photochromic material within the polymeric coating migrates out of the polymeric coating and into an adjacent superposed layer placed on top of the photochromic polymeric coating. In some instances, the superposed layer is an abrasion resistant coating, while in other instances the superposed layer is the aforedescribed organic polymeric tie layer.

It has now been discovered that providing an appropriate amount of a polysiloxane surface active agent, e.g., a polysiloxane polyol, within the photochromic coating can substantially attenuate the problems of photochromic migration. More particularly, it has been discovered that such migration problems can be substantially attenuated by incorporating a migration inhibiting amount of a polysiloxane surface active agent within the photochromic polymeric coating.

In accordance with one embodiment of the present invention, there is contemplated a photochromic article, e.g., a lens, comprising, in combination:
(a) a rigid transparent substrate; and
(b) a transparent organic polymeric coating superposed on at least a portion of at least one surface of said polymeric substrate, said polymeric coating comprising at least one organic photochromic material and at least one polysiloxane surface active agent.

In another embodiment of the present invention, there is contemplated the above-described transparent photochromic article further comprising an abrasion-resistant coating, such as a hard coating comprising an organo silane, that is appended to the exposed surface of the photochromic polymeric coating. In a further embodiment of the present invention, there is contemplated a photochromic article that has a second polymeric tie layer superposed on the photochromic polymeric coating and the aforedescribed abrasion resistant coating appended to the polymeric tie layer. In yet other embodiments of the present invention, an antireflective coating is applied to the abrasion-resistant coating of the previously described embodiments. Other coatings, such as antistatic and/or antiwetting coatings can also be applied to the antireflective coating.

In a still further embodiment of the present invention, there is contemplated an ophthalmic photochromic article comprising, in combination:
(a) a transparent organic plastic substrate, such as a rigid thermoset substrate prepared from a polymerizable composition comprising an allyl diglycol carbonate, such as diethylene glycol bis(allyl carbonate), a substrate prepared from thermoplastic polycarbonate, a substrate prepared from a polyurea urethane, or a substrate prepared from compositions comprising the reaction product of polyfunctional isocyanate(s) and polythiols or polyepisulfide monomer(s);
(b) an optically clear organic polymeric photochromic coating, such as an acrylic-based, polyurethane-based, polyurea urethane-based, aminoplast resin-based or polyepoxy-based photochromic coating, appended to at least a portion of at least one surface of said plastic substrate, said polymeric photochromic coating comprising a photochromic amount of at least one organic photochromic material and a photochromic material migration inhibiting amount of a polysiloxane surface active agent;
(c) an optically clear, organic polymeric tie layer, e.g., coating or film, adhered coherently to said photochromic coating; and
(d) optionally an abrasion resistant coating, such as an organo silane-containing hard coating, adhered to said polymeric tie layer. In yet a further contemplated embodiment, an antireflective coating is adhered to said abrasion-resistant coating, assuming that the abrasion-resistant coating is present, or to said polymeric tie layer.

### DETAILED DESCRIPTION OF THE INVENTION

In accordance with the present invention, there is provided a photochromic article comprising, in combination, a rigid substrate, e.g., a transparent substrate such as glass or an organic polymeric material, and a photochromic polymeric coating affixed to at least a portion of at least one surface of the rigid substrate, the photochromic polymeric coating comprising a photochromic amount of at least one photochromic material, e.g., dye or compound, and a photochromic material migration inhibiting amount of at least one polysiloxane surface active agent. In a further embodiment of the present invention, an abrasion resistant coating, e.g., an organo silane hard coating, is applied to the photochromic polymeric coating or to an organic polymeric tie layer superposed on the photochromic polymeric coating. In a still further contemplated embodiment, additional coatings are applied to the abrasion resistant coating. Such additional coatings can include, but are not limited to, antireflective coatings, antistatic coatings, water repellant coatings and combinations of such coatings.

For purposes of this specification (other than in the operating examples), unless otherwise indicated, all numbers expressing quantities and ranges of ingredients, reaction conditions, etc., such as those expressing refractive indices and wavelengths, are to be understood as modified in all instances by the term “about”. Accordingly, unless indicated to the contrary, the numerical parameters set forth in this specification and attached claims are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

As used in this description and claims, the term “cure”, “cured” or similar terms, as used in connection with a cured or curable composition, e.g., a “cured composition” of some specific description, is intended to mean that at least a portion of the polymerizable and/or cross-linkable components that form the curable composition are at least partially polymerized and/or cross-linked. In certain embodiments, the cross-link density of the cross-linkable components, e.g., the degree of cross-linking, can range from 5% to 100% of complete cross-linking. In other embodiments, the cross-link density can range from 35% to 85%, e.g., 50 to 85%, of full cross-linking. The degree of cross-linking can range between any combination of the previously stated values, inclusive of the recited values.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The specific citation in this specification of patent applications, published or granted patents and published articles, such as the disclosures in identified patents that are referred to by column and line number, which describe relevant methods for preparing monomers, polymerizates, coatings, articles of manufacture, photochromic compounds, etc. are incorporated herein, in toto, by reference.

In accordance with the present invention, the photochromic polymeric coating contains at least one polysiloxane surface active agent. The polysiloxane surface active agent(s) is incorporated into the curable photochromic polymeric coating composition prior to that coating composition being applied to the surface of the polymeric substrate, and is incorporated in amounts sufficient to significantly inhibit the migration of photochromic materials within the coating to the surface of the coating and thence into a superposed coating layer, e.g., an abrasion resistant coating, an organic polymeric tie layer or some other organic film or coating, e.g., a migration inhibiting amount. This amount can vary widely depending on the particular polysiloxane surface active agent used. Desirably, the amount of polysiloxane added to the photochromic coating composition will be an amount that does not result in the formation of a significant amount of haze in the photochromic coating and/or that does not result in blooming of the photochromic coating, e.g., blooming caused by the polysiloxane migrating to the surface of the coating. When the polysiloxane is a non-reactive polysiloxane, which polysiloxanes are typically of low molecular weight, the amount used will typically range from 0.6 to 5 weight percent, e.g., 1.5 to 2 weight percent, based on the total amount of polymerizable resin solids that comprise the curable photochromic polymeric coating composition. When the polysiloxane is a reactive siloxane, e.g., hydroxy-containing polysiloxane, which are typically of higher molecular weight, such polysiloxanes can be a component of the polymer structure formed by curing the composition comprising the photochromic material and organic polymerizable components, e.g., a polyurethane-based photochromic polymeric coating, and the amount of polysiloxane used can be higher, e.g., as high as 90% of the polymerizable resin solids that comprise the photochromic polymeric coating. In this later instance, the amount of polysiloxane surface active agent used can vary from 0.6 to 90%, e.g., 1 to 50%, more particularly from 5 to 25%. The amount of polysiloxane used can vary between any of the recited percentages, inclusive of the stated percentages.

The polysiloxane surface active agent(s), particularly the low molecular weight non-reactive polysiloxanes, will generally have a weight average molecular weight in excess of 250, e.g., from 250 from 1000, will be dispersible within the curable photochromic polymeric coating composition, and will not significantly adversely affect, e.g., decrease, the optical properties of the cured photochromic polymeric coating. Similarly, polysiloxanes of higher molecular weight, particularly the reactive polysiloxanes, will generally have a weight average molecular weight of from 1000 to 50,000, e.g., from 5,000 to 25,000, will be dispersible within the curable photochromic polymeric coating composition, and will not significantly adversely affect the optical properties of the cured photochromic polymeric coating. The aforementioned polysiloxane surface active agents are known in the art. See, for example, U.S. Pat. No. 6,387,519 B1.

In one embodiment of the present invention, the at least one surface active agent is chosen from polysiloxanes comprising at least one reactive functional group. The at least one polysiloxane surface active agent can comprise a material that can be represented by the following general formula (I):
R¹ₙR²ₘSiO_{(4-n-m)/2} (I)
wherein each R¹, which can be identical or different, represents H, OH, a monovalent hydrocarbon group, or a monovalent siloxane group; each R², which can be identical or different, represents a group comprising at least one reactive functional group, and wherein m and n fulfill the requirements of 0<n<4, 0<m<4 and 2≦(m+n)<4. When (m+n) is 3, the value represented by n can be 2 and the value represented by m is 1. Likewise, when (m+n) is 2, the value represented by each of n and m is 1.

It should be understood that the at least one polysiloxane represented by the general formula (I) above is a polymer that contains at least two Si atoms per molecule. As set forth above, the term “polymer” is meant to encompass oligomers, and includes without limitation both homopolymers and copolymers. It should also be understood that the at least one polysiloxane can include linear, branched, dendritic or cyclic polysiloxanes. Also, as used herein, the term “reactive” refers to a functional group that forms a covalent bond with another functional group under conditions sufficient to cure the composition.

As used herein, the term “monovalent hydrocarbon group” means a monovalent organic group having a backbone repeat unit containing essentially carbon and hydrogen. As used herein, “monovalent” refers to a substituent group that, as a substituent group, forms only one single, covalent bond. For example a monovalent group on the at least one polysiloxane will form one single covalent bond to a silicon atom in the backbone of the at least one polysiloxane polymer. As used herein, “hydrocarbon groups” are intended to encompass both branched or unbranched hydrocarbon groups.

Thus, when referring to a “monovalent hydrocarbon group,” the hydrocarbon group can be branched or unbranched, acyclic or cyclic, saturated or unsaturated, aliphatic or aromatic, and can contain from 1 to 24 (or in the case of an aromatic group from 6 to 24) carbon atoms. Non-limiting examples of such hydrocarbon groups include alkyl, alkoxy, aryl, alkaryl, and alkoxyaryl groups. Non-limiting examples of lower alkyl groups include methyl, ethyl, propyl and butyl groups. As used herein, “lower alkyl” refers to alkyl groups having from 1 to 6 carbon atoms, e.g., from 1 to 4 carbon atoms. One or more of the hydrogen atoms of the hydrocarbon can be substituted with heteroatoms. As used herein, “heteroatoms” means elements other than carbon, e.g., oxygen, nitrogen and halogen atoms.

As used herein, “siloxane” means a group comprising a backbone comprising two or more —SiO— groups. For example, the siloxane groups represented by R¹ in formula I, which is discussed above, and R, which is discussed below, can be branched or unbranched, and linear or cyclic. The siloxane groups can be substituted with pendant organic substituent groups, for example, alkyl, aryl and alkaryl groups. The organic substituent groups can be substituted with heteroatoms, for example, oxygen, nitrogen and halogen atoms, reactive functional groups, for example, those reactive functional groups discussed above with reference to R², and mixtures of any of the foregoing.

In another embodiment, each substituent group R² in formula I, which is discussed above, represents a group comprising at least one reactive functional group chosen from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, such as an acrylate group and a methacrylate group, a maleimide group, a fumarate group, an onium salt group such as a sulfonium group and an ammonium group, an anhydride group, a hydroxy alkylamide group or an epoxy group; wherein m and n fulfill the requirements of 0<n<4, 0<m<4 and 2≦(m+n)<4.

In one embodiment, the at least one polysiloxane comprises at least two reactive functional groups. The at least one polysiloxane can have a reactive group equivalent weight ranging from 50 to 1000 mg per gram of the at least one polysiloxane. In one embodiment, the at least one polysiloxane has a hydroxyl group equivalent weight ranging from 50 to 1000 mg KOH per gram of the at least one polysiloxane. In another embodiment, the at least one polysiloxane has a hydroxyl group equivalent weight ranging from 100 to 300 mg KOH per gram of the at least one polysiloxane, while in another embodiment, the hydroxyl group equivalent weight ranges from 100 to 500 mg KOH per gram.

In another embodiment, the R² group represents a group comprising at least one reactive functional group chosen from a hydroxyl group or a carbamate group. In yet another embodiment, the R² group represents a group comprising at least two reactive functional groups chosen from a hydroxyl group or a carbamate group. In still another embodiment, at least one of the R² group represents a group comprising an oxyalkylene group and at least two hydroxyl groups.

In a further embodiment, the at least one polysiloxane comprises reactive functional groups, which are thermally curable functional groups. In an alternative embodiment, at least one of the reactive functional groups of the polysiloxane can be curable by actinic radiation. In another alternative embodiment, the polysiloxane can comprise at least one functional group that is curable by thermal energy and at least one functional group that is curable by ionizing radiation or actinic radiation.

As used herein, “ionizing radiation” means high energy radiation or the secondary energies resulting from conversion of electron or other particle energy to neutron or gamma radiation, said energies being at least 30,000 electron volts and can be 50,000 to 300,000 electron volts. While various types of ionizing radiation are suitable, e.g., X-ray, gamma and beta rays, the radiation produced by accelerated high energy electrons or electron beam devices are specifically contemplated.

“Actinic radiation” is light with wavelengths of electromagnetic radiation ranging from the ultraviolet (“UV”) light range through the visible light range, and into the infrared range. Actinic radiation generally has wavelengths of electromagnetic radiation ranging from 150 to 2,000 nanometers (nm), e.g., from 180 to 1,000 nm, and more particularly, from 200 to 500 nm. Non-limiting examples of ultraviolet light sources include mercury arcs, carbon arcs, low, medium or high pressure mercury lamps, swirl-flow plasma arcs and ultraviolet light emitting diodes. Typically, ultraviolet light-emitting lamps are medium pressure mercury vapor lamps having outputs ranging from 200 to 600 watts per inch (79 to 237 watts per centimeter) across the length of the lamp tube. Generally, a 1 mil (25 micrometers) thick actinic radiation curable film can be cured through its thickness to a tack-free state upon exposure to actinic radiation by passing the film at a rate of 20 to 1000 feet per minute (6 to 300 meters per minute) under four medium pressure mercury vapor lamps of exposure at 200 to 1000 millijoules per square centimeter of the wet film.

Radiation-curable groups that can be present as reactive functional groups on the polysiloxane include unsaturated groups such as vinyl groups, vinyl ether groups, epoxy groups, maleimide groups, fumarate groups and combinations of the foregoing unsaturated groups. In one embodiment, the UV curable groups can include acrylate groups, maleimides, fumarates and vinyl ethers. Particular vinyl groups include those having unsaturated ester groups and vinyl ether groups, as discussed hereinafter.

In a further embodiment, the at least one polysiloxane can be represented by the following general formulae (II) or (III): 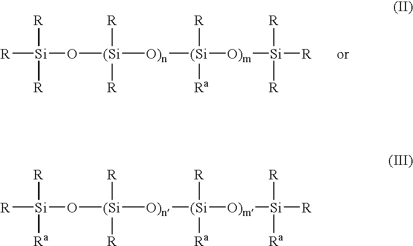
wherein m has a value of at least 1; m′ ranges from 0 to 75; n ranges from 0 to 75; n′ ranges from 0 to 75; each R, which can be identical or different, is chosen from H, OH, a monovalent hydrocarbon group, a monovalent siloxane group or mixtures of the foregoing groups. In another embodiment, the values for (n+m) and (n′+m′) can range from 2 to 9, e.g., from 2 to 3. In formulae (II) and (III), —R^{a} is represented by the following general formula (IV):
—R³—X (IV)
wherein —R³ is chosen from an alkylene group, an oxyalkylene group, an alkylene aryl group, an alkenylene group, an oxyalkenylene group or an alkenylene aryl group; and X represents a group that comprises at least one reactive functional group chosen from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, such as an acrylate group and a methacrylate group, a maleimide group, a fumarate group, an onium salt group, such as a sulfonium group and an ammonium group, an anhydride group, a hydroxy alkylamide group or an epoxy group. In a particular embodiment, X represents a group that comprises at least two reactive functional groups.

In one embodiment, X in formula IV represents a group comprising at least one reactive functional group chosen from a hydroxyl group or a carbamate group. In another embodiment, X represents a group, which comprises at least two hydroxyl groups. In yet another embodiment, X represents a group that comprises at least one group chosen from H, a monohydroxy-substituted organic group or a group represented by the following general formula (V):
—R⁴—(—CH₂—OH)ₚ (V)
wherein the substituent group R⁴ represents 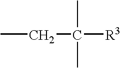
when p is 2, and the substituent group R³ represents a C₁ to C₄ alkylene group, or the substituent group R⁴ represents 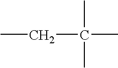
when p is 3.

In one contemplated embodiment, at least a portion of X represents a group corresponding to formula (V). In another embodiment, m is 2 and p is 2.

In a still further embodiment, the at least one polysiloxane can be represented by the following general formulae VI and VII for polysiloxane polyols: 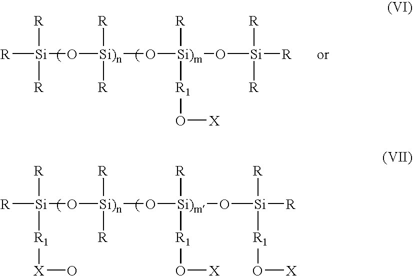
wherein n is 0 to 50; m is at least one; m′ is 0 to 50; R is chosen from OH or monovalent hydrocarbon groups attached to the silicon atoms; R₁ is alkylene, oxyalkylene or alkylene aryl; and the moiety X is H, mono-hydroxy-substituted alkylene, oxyalkylene or —R₂—(—CH₂—OH)ₚ wherein p is 2 or 3, and 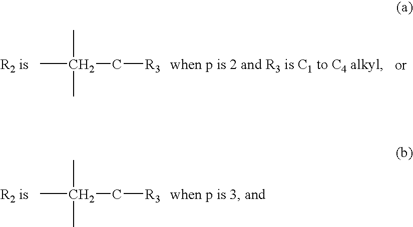
wherein at least a portion of the moiety X is R₂—(—CH₂—OH)ₚ.
In one particular embodiment, R₁ is C₃H₆ and p is 2.

Formulae (II), (III), (VI) and (VII) are diagrammatic, and it is not intended to imply that the parenthetical (or bracketed) portions are necessarily blocks, although blocks can be used where desired. In many cases the compound is more or less random, especially when more than a few siloxane units are employed and when mixtures are used. In those instances where more than a few siloxane units are used and it is desired to form blocks, oligomers are first formed and then these are joined to form the block compound. By judicious choice of reactants, compounds having an alternating structure or blocks of alternating structure can be used.

As used herein, “alkylene” refers to an acyclic or cyclic, saturated hydrocarbon group having a carbon chain length of from C2 to C25. Non-limiting examples of suitable alkylene groups include, but are not limited to, those derived from propenyl, 1-butenyl, 1-pentenyl, 1-decenyl and 1-heneicosenyl, such as for example, (CH2)3, (CH2)4, (CH2)5, (CH2)10, and (CH2)23, respectively, as well as isoprene and myrcene.

As used herein, “oxyalkylene” refers to an alkylene group containing at least one oxygen atom bonded to, and interposed between, two carbon atoms and having an alkylene carbon chain length of from C2 to C25. Non-limiting examples of suitable oxyalkylene groups include those derived from trimethylolpropane monoallyl ether, trimethylolpropane diallyl ether, pentaerythritol monoallyl ether, polyethoxylated allyl alcohol and polypropoxylated allyl alcohol, such as
—(CH₂)₃OCH₂C(CH₂OH)₂(CH₂CH₂—).

As used herein, “alkylene aryl” refers to an acyclic alkylene group substituted with at least one aryl group, for example, phenyl, and having an alkylene carbon chain length of C2 to C25. The aryl group can be further substituted, if desired. Non-limiting examples of suitable substituent groups for the aryl group include, but are not limited to, hydroxyl groups, benzyl groups, carboxylic acid groups and aliphatic hydrocarbon groups. Non-limiting examples of suitable alkylene aryl groups include, but are not limited to, those derived from styrene and 3-isopropenyl-∝,∝-dimethylbenzyl isocyanate, such as —(CH2)2C6H4- and —CH2CH(CH3)C6H3(C(CH3)2(NCO).

As used herein, “alkenylene” refers to an acyclic or cyclic hydrocarbon group having one or more double bonds and having an alkenylene carbon chain length of C2 to C25. Non-limiting examples of suitable alkenylene groups include those derived from propargyl alcohol and acetylenic diols, for example, 2,4,7,9-tetramethyl-5-decyne4,7-diol, which is commercially available from Air Products and Chemicals, Inc. of Allentown, Pa. as SURFYNOL 104.

The at least one polysiloxane is the reaction product of at least the following reactants:

(i) at least one polysiloxane that can be represented by formula (VIII): 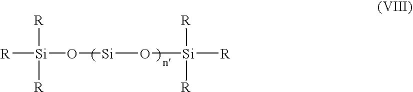
wherein each substituent group R, which can be identical or different, represents a group chosen from H, OH, a monovalent hydrocarbon group, a monovalent siloxane group, or mixtures of any of the foregoing groups, at least one of the groups represented by R is H, and n′ ranges from 0 to 100. n′ also can range from 0 to 10, e.g., from 0 to 5, such that the percent of SiH content of the polysiloxane ranges from 2 to 50 percent, e.g., from 5 to 25 percent; and

(ii) at least one molecule which comprises at least one functional group chosen from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, such as an acrylate group and a methacrylate group, a maleimide group, a fumarate group, an onium salt group, such as a sulfonium group and an ammonium group, an anhydride group, a hydroxy alkylamide group or an epoxy group, and at least one unsaturated bond capable of undergoing a hydrosilylation reaction. In another embodiment, the at least one functional group is chosen from hydroxyl groups.

It should be appreciated that the various R groups of formula VIII can be the same or different, and, in certain embodiments, the R groups will be entirely monovalent hydrocarbon groups or will be a mixture of different groups such as monovalent hydrocarbon groups and hydroxyl groups.

Non-limiting examples of polysiloxanes containing silicon hydride, e.g., reactant (i), include 1,1,3,3-tetramethyl disiloxane where n′ is 0 and the average Si—H functionality is two; and polymethyl polysiloxane containing silicon hydride, where n′ ranges from 4 to 5 and the average Si—H functionality is approximately two, such as is commercially available from BASF Corporation as MASILWAX BASE® or from the Lubrizol Corporation.

Materials for use as reactant (ii) above can include hydroxyl functional group-containing allyl ethers, such as those chosen from trimethylolpropane monoallyl ether, pentaerythritol monoallyl ether and trimethylolpropane diallyl ether; polyoxyalkylene alcohols, such as polyethoxylated alcohol, polypropoxylated alcohol and polybutoxylated alcohol; undecylenic acid-epoxy adducts; allyl glycidyl ether-carboxylic acid adducts, and mixtures of any of the foregoing. Mixtures of hydroxyl functional polyallyl ethers with hydroxyl functional monoallyl ethers or allyl alcohols are suitable as well. In certain instances, reactant (ii) can contain at least one unsaturated bond in a terminal position. Reaction conditions and the ratio of reactants (i) and (ii) are chosen so as to form the desired functional group.

The hydroxyl functional group-containing polysiloxane can be prepared by reacting a polysiloxane containing hydroxyl functional groups with an anhydride to form the half-ester acid group under reaction conditions that favor only the reaction of the anhydride and the hydroxyl functional groups, and avoid further esterification from occurring. Non-limiting examples of suitable anhydrides include hexahydrophthalic anhydride, methyl hexahydrophthalic anhydride, phthalic anhydride, trimellitic anhydride, succinic anhydride, chlorendic anhydride, alkenyl succinic anhydride, substituted alkenyl anhydrides, such as octenyl succinic anhydride, and mixtures of any of the foregoing anhydrides.

The half-ester group-containing reaction product thus prepared can be further reacted with a monoepoxide to form a polysiloxane containing secondary hydroxyl group(s). Non-limiting examples of suitable monoepoxides are phenyl glycidyl ether, n-butyl glycidyl ether, cresyl glycidyl ether, isopropyl glycidyl ether, glycidyl versatate, for example CARDURA E available from Shell Chemical Co., and mixtures of any of the foregoing.

In another embodiment, the at least one polysiloxane is a carbamate functional group-containing polysiloxane which comprises the reaction product of at least the following reactants:

(i) at least one polysiloxane containing silicon hydride of formula (VIII) above where R and n′ are as described above for that formula;

(ii) at least one hydroxyl functional group-containing material having one or more unsaturated bonds capable of undergoing hydrosilylation reaction as described above; and

(iii) at least one low molecular weight carbamate functional material, comprising the reaction product of an alcohol or glycol ether and a urea.

Examples of such “low molecular weight carbamate functional material” include, but are not limited to, alkyl carbamate and hexyl carbamates, and glycol ether carbamates, such as those described in U.S. Pat. Nos. 5,922,475 and 5,976,701.

The carbamate functional groups can be incorporated into the polysiloxane by reacting the hydroxyl functional group-containing polysiloxane with the low molecular weight carbamate functional material via a “transcarbamoylation” process. The low molecular weight carbamate functional material, which can be derived from an alcohol or glycol ether, can react with free hydroxyl groups of a polysiloxane polyol, e.g., a material having an average of two or more hydroxyl groups per molecule, yielding a carbamate functional polysiloxane and the original alcohol or glycol ether. Reaction conditions and the ratio of reactants (i), (ii) and (iii) are chosen so as to form the desired groups.

The low molecular weight carbamate functional material can be prepared by reacting the alcohol or glycol ether with urea in the presence of a catalyst such as butyl stannoic acid. Non-limiting examples of suitable alcohols include lower molecular weight aliphatic, cycloaliphatic and aromatic alcohols, for example methanol, ethanol, propanol, butanol, cyclohexanol, 2-ethylhexanol and 3-methylbutanol. Non-limiting examples of suitable glycol ethers include ethylene glycol methyl ether and propylene glycol methyl ether. The incorporation of carbamate functional groups into the polysiloxane also can be achieved by reacting isocyanic acid with free hydroxyl groups of the polysiloxane.

As aforementioned, in addition to or in lieu of hydroxyl and/or carbamate functional groups, the at least one polysiloxane can comprise one or more other reactive functional groups such as carboxyl groups, isocyanate groups, blocked isocyanate groups, carboxylate groups, primary amine groups, secondary amine groups, amide groups, urea groups, urethane groups, epoxy groups and mixtures of any of the foregoing groups.

When at least one polysiloxane contains carboxyl functional groups, the at least one polysiloxane can be prepared by reacting at least one polysiloxane containing hydroxyl functional groups as described above with a polycarboxylic acid or anhydride. Non-limiting examples of polycarboxylic acids suitable for use include adipic acid, succinic acid and dodecanedioic acid. Non-limiting examples of suitable anhydrides include those described above. Reaction conditions and the ratio of reactants are chosen so as to form the desired functional groups.

In the case where at least one polysiloxane contains one or more isocyanate functional groups, the at least one polysiloxane can be prepared by reacting at least one polysiloxane containing hydroxyl functional groups, as described above, with a polyisocyanate, such as a diisocyanate. Non-limiting examples of suitable polyisocyanates include aliphatic polyisocyanates, such as for example, aliphatic diisocyanates, for example 1,4-tetramethylene diisocyanate and 1,6-hexamethylene diisocyanate; cycloaliphatic polyisocyanates, for example 1,4-cyclohexyl diisocyanate, isophorone diisocyanate, and α,α-xylylene diisocyanate; and aromatic polyisocyanates, for example 4,4′-diphenylmethane diisocyanate, 1,3-phenylene diisocyanate, and tolylene diisocyanate. These and other suitable polyisocyanates are described in more detail in U.S. Pat. No. 4,046,729, at column 5, line 26 to column 6, line 28. Reaction conditions and the ratio of reactants are chosen so as to form the desired functional groups.

The substituent group X in structure (IV) can comprise a polymeric urethane or urea-containing material that is terminated with isocyanate, hydroxyl, primary or secondary amine functional groups, or mixtures of any of the foregoing. When the substituent group X comprises such functional groups, the at least one polysiloxane can be the reaction product of at least one polysiloxane polyol as described above, one or more polyisocyanates and, optionally, one or more compounds having at least two active hydrogen atoms per molecule chosen from hydroxyl groups, primary amine groups and secondary amine groups.

Non-limiting examples of suitable polyisocyanates are those described above. Non-limiting examples of compounds having at least two active hydrogen atoms per molecule include polyols and polyamines containing primary and/or secondary amine groups.

Non-limiting examples of suitable polyols include polyalkylene ether polyols, including thio ethers; polyester polyols, including polyhydroxy polyesteramides; and hydroxyl-containing polycaprolactones and hydroxy-containing acrylic interpolymers. Also useful are polyether polyols formed from the oxyalkylation of various polyols, for example glycols such as ethylene glycol, 1,6-hexanediol, Bisphenol A, and the like, or higher polyols such as trimethylolpropane, pentaerythritol and the like. Polyester polyols also can be used. These and other polyols are described in U.S. Pat. No. 4,046,729 at column 7, line 52 to column 8, line 9; column 8, line 29 to column 9, line 66; and in U.S. Pat. No. 3,919,315 at column 2, line 64 to column 3, line 33.

Non-limiting examples of suitable polyamines include primary or secondary diamines or polyamines in which the groups attached to the nitrogen atoms can be saturated or unsaturated, aliphatic, alicyclic, aromatic, aromatic-substituted-aliphatic, aliphatic-substituted-aromatic and heterocyclic. Non-limiting examples of aliphatic and alicyclic diamines include 1,2-ethylene diamine, 1,2-propylene diamine, 1,8-octane diamine, isophorone diamine, propane-2,2-cyclohexyl amine, and the like. Non-limiting examples of aromatic diamines include phenylene diamines and the toluene diamines, for example o-phenylene diamine and p-tolylene diamine. These and other polyamines are described in detail in U.S. Pat. No. 4,046,729 at column 6, line 61 to column 7, line 26.

In one embodiment, the substituent group X of the structure (IV) can comprise a polymeric ester-containing group, which is terminated with hydroxyl or carboxylic acid functional groups. When X is such a group, the at least one polysiloxane can be the reaction product of one or more polysiloxane polyols, as described above, one or more materials having at least one carboxylic acid functional group, and one or more organic polyols. Non-limiting examples of materials having at least one carboxylic acid functional group include carboxylic acid group-containing polymers well-known in the art, for example carboxylic acid group-containing acrylic polymers, polyester polymers, and polyurethane polymers, such as those described in U.S. Pat. No. 4,681,811. Non-limiting examples of organic polyols include those described above.

To form the at least one polysiloxane containing epoxy groups, at least one polysiloxane containing hydroxyl functional groups, as described above, can be further reacted with a polyepoxide. The polyepoxide can be an aliphatic or cycloaliphatic polyepoxide or mixtures of any of the foregoing. Non-limiting examples of polyepoxides suitable for use include epoxy functional acrylic copolymers prepared from at least one ethylenically unsaturated monomer having at least one epoxy group, for example glycidyl (meth)acrylate and allyl glycidyl ether, and one or more ethylenically unsaturated monomers which have no epoxy functionality. The preparation of such epoxy functional acrylic copolymers is described in detail in U.S. Pat. No. 4,681,811 at column 4, line 52 to column 5, line 50. Reaction conditions and the ratio of reactants are chosen so as to form the desired functional groups.

In a further embodiment of the present invention, inorganic particles, composite particles and mixtures of such particles are also incorporated into the photochromic polymeric coating. Such particles will have an average particle size ranging from 1 to 1000 nanometers, e.g., from 1 to 100 nanometers, prior to being incorporated into the photochromic polymeric coating. More particularly, the average particle size of the particles ranges from 5 to 50 nanometers, e.g., 5 to 25 nanometers, prior to incorporation into the composition. The average particle size can range between any combination of these values inclusive of the recited values.

As used herein, the term “inorganic material” means any material that is not an organic material. As used herein, the term “composite material” means a combination of two or more differing materials. The particles formed from composite materials generally have a hardness at their surface that is different from the hardness of the internal portions of the particle beneath its surface. More specifically, the surface of the particle can be modified in any manner well known in the art, including, but not limited to, chemically or physically changing its surface characteristics using techniques known in the art.

For example a particle can be formed from a primary material that is coated, clad or encapsulated with one or more secondary materials to form a composite particle that has a softer surface. In yet another alternative embodiment, particles formed from composite materials can be formed from a primary material that is coated, clad or encapsulated with a different form of the primary material. For more information on particles useful in the present invention, see G. Wypych, Handbook of Fillers, 2nd Ed. (1999) at pages 15-202.

The particles used in the photochromic polymeric coating can comprise inorganic elements or compounds known in the art. Particles can be formed from ceramic materials, metallic materials, and mixtures of any of the foregoing. Ceramic materials comprise metal oxides, metal nitrides, metal carbides, metal sulfides, metal silicates, metal borides, metal carbonates and mixtures of any of the foregoing. Specific, non-limiting examples of metal nitrides are, for example boron nitride; specific, non-limiting examples of metal oxides are, for example zinc oxide; non-limiting examples of suitable metal sulfides are, for example molybdenum disulfide, tantalum disulfide, tungsten disulfide and zinc sulfide; non-limiting suitable examples of metal silicates are, for example aluminum silicates and magnesium silicates, such as vermiculite.

The particles can comprise, for example a core of essentially a single inorganic oxide such as silica in colloidal, fumed or amorphous form, alumina or colloidal alumina, titanium dioxide, cesium oxide, yttrium oxide, colloidal yttria, zirconia, e.g., colloidal or amorphous zirconia, and mixtures of any of the foregoing inorganic oxides; or an inorganic oxide of one type upon which is deposited an organic oxide of another type. It should be understood that the particles should not seriously interfere with the optical properties of the photochromic polymeric coating.

Non-polymeric, inorganic materials useful in forming the particles incorporated into the photochromic polymeric coating can comprise inorganic materials chosen from oxides, carbides, nitrides, borides, sulfides, silicates, carbonates, sulfates or hydroxides. A non-limiting example of a useful inorganic oxide is zinc oxide. Non-limiting examples of suitable inorganic sulfides include molybdenum disulfide, tantalum disulfide, tungsten disulfide, and zinc sulfide. Non-limiting examples of useful inorganic silicates include aluminum silicates and magnesium silicates, such as vermiculite.

In one embodiment, the particles are chosen from fumed silica, amorphous silica, colloidal silica, alumina, colloidal alumina, titanium dioxide, cesium oxide, yttrium oxide, colloidal yttria, zirconia, colloidal zirconia or mixtures of any of the foregoing. In another embodiment, the particles include colloidal silica. As disclosed above, these materials can be surface treated or untreated.

Precursors for forming silica particles in situ by a sol-gel process can also be used. The precursors can comprise alkoxy silanes that can be hydrolyzed to form silica particles in situ. For example tetraethylorthosilicate can be hydrolyzed with an acid such as hydrochloric acid and condensed to form silica particles. Other useful particles include surface-modified silicas, such as are described in U.S. Pat. No. 5,853,809 at column 6, line 51 to column 8, line 43.

The particles incorporated into the photochromic polymeric coating can be incorporated in amounts of less than 25 weight percent, based on the total weight of the resin solids of the components that form the coating composition. In particular, the particles will be present in amounts of less than 10 weight percent, e.g., less than 5 weight percent. If present, the particles will typically be incorporated into the photochromic polymeric coating in amounts of at least 0.1 weight percent, e.g., at least 0.5 weight percent. It should be understood that the particles are not required to be in the photochromic coating and hence the particles can be present in an amount 0 percent (zero percent). The particles can be present in the coating in a range that varies between any combination of the stated values, including the recited values. When so incorporated, the particles are present in a size, dimension and quantity so as not to adversely affect, e.g., diminish, the optical properties of the photochromic organic polymeric coating.

As used herein, the term “based on total weight of the resin solids” of the components which form the composition means that the amount of the component added during the formation of the composition is based upon the total weight of the solids (non-volatiles) of the polysiloxane, any film-forming component, any curing agent present during the formation of the composition, and any silyl-blocked material present, but not including the particles, any solvent, or any additive solids such as hindered amine stabilizers, catalysts, pigments including extender pigments and fillers, photoinitiators, flow additives, and UV light absorbers.

Prior to incorporation, one class of particles that can be used include sols, such as an organosol, of the particles. These sols can be of a wide variety of small-particle, colloidal silicas having an average particle size in ranges such as identified above.

The colloidal silicas can be surface modified during or after the particles are initially formed. These surface modified silicas can contain on their surface chemically bonded carbon-containing moieties, as well as such groups as anhydrous SiO2 groups and SiOH groups, various ionic groups physically associated or chemically bonded within the surface of the silica, adsorbed organic groups, or combinations of any of the foregoing, depending on the characteristics of the particular silica desired. Such surface modified silicas are described in detail in U.S. Pat. No. 4,680,204.

Such materials can be prepared by a variety of techniques in various forms, non-limiting examples of which, include organosols and mixed sols. As used herein the term “mixed sols” is intended to include those dispersions of colloidal silica in which the dispersing medium comprises both an organic liquid and water. Such small particle colloidal silicas are readily available, are essentially colorless and have refractive indices that permit their inclusion in compositions that results in colorless, transparent coatings.

Suitable non-limiting examples of particles include colloidal silicas, such as those commercially available from Nissan Chemical Company under the trademark ORGANOSILICASOLS™ such as ORGANOSILICASOL™ MT-ST, and from Clariant Corporation as HIGHLINK™; colloidal aluminas, such as those commercially available from Nalco Chemical under the trademark NALCO 8676®; and colloidal zirconias, such as those commercially available from Nissan Chemical Company under the trademark HIT-32M®.

The particles can be incorporated into the composition comprising the curable photochromic coating in the form of a stable dispersion. When the particles are in a colloidal form, the dispersions can be prepared by dispersing the particles in a carrier under agitation and solvent that is present can be removed under vacuum at ambient temperatures. In certain embodiments, the carrier can be other than a solvent, such as the siloxane surface active agents described in detail herein, including, but not limited to, a polysiloxane containing reactive functional groups, including, but not limited to, the at least one polysiloxane.

Alternatively, the dispersions can be prepared by the methods described in U.S. Pat. No. 4,522,958 or U.S. Pat. No. 4,526,910. The particles can be “cold-blended” with the at least one polysiloxane prior to incorporation. Alternatively, the particles can be post-added to an admixture of any remaining composition components (including, but not limited to, the at least one polysiloxane and dispersed therein using dispersing techniques well-known in the art.

When the particles are in other than colloidal form, such as for example in agglomerate form, the dispersions can be prepared by dispersing the agglomerate in the carrier, e.g., the at least one polysiloxane (a), to stably disperse the particles therein. Dispersion techniques such as grinding, milling, microfluidizing, ultrasounding, or any other pigment dispersing techniques well known in the art of coatings formulation can be used. Alternatively, the particles can be dispersed by any other dispersion techniques known in the art. If desired, the particles in other than colloidal form can be post-added to an admixture of other composition components and dispersed therein using any dispersing techniques known in the art.

Rigid substrates to which the photochromic polymeric coating are applied can vary and include any rigid substrate that will support a photochromic polymeric coating. Non-limiting examples of such rigid substrates include: paper, glass, ceramics, wood masonry, textiles, metals and organic polymeric materials. The particular substrate used will depend on the particular application that requires both a rigid substrate and a photochromic coating. In desired embodiment, the rigid substrate is transparent. Polymeric substrates that can be used in preparing the photochromic articles of the present invention include organic polymeric materials and inorganic materials, such as glass. As used herein, the term “glass” is defined as being a polymeric substance, e.g., a polymeric silicate. Glass substrates can be of any type suitable for the intended purpose; but, are desirably a clear, low colored, transparent glass such as the well-known silica type of glass, particularly soda-lime-silica glass. The nature and composition of various silica glasses are well known in the art. The glass can be strengthened by either thermal or chemical tempering.

Polymeric organic substrates that can be used in preparing the photochromic articles of the present invention, are any of the currently known (or later discovered) plastic materials that are chemically compatible with the photochromic polymeric coating superposed on, e.g., applied to, the surface of the substrate. Particularly contemplated are the art-recognized polymers that are useful as optical substrates, e.g., organic optical resins that are used to prepare optically clear castings for optical applications, such as ophthalmic lenses.

Non limiting examples of organic substrates that can be used as polymeric organic substrates are polymers, e.g., homopolymers, oligomers and copolymers, prepared from the monomers and mixtures of monomers disclosed in U.S. Pat. No. 5,962,617 and from column 15, line 28 to column 16, line 17 of U.S. Pat. No. 5,658,501. Such organic substrates can be thermoplastic or thermoset polymeric substrates, e.g., transparent, more particularly, optically clear, substrates having a refractive index that desirably ranges from 1.48 to 1.74, e.g., 1.50 to 1.67.

Non-limiting examples of such disclosed monomers and polymers include: polyol(allyl carbonate) monomers, e.g., allyl diglycol carbonates such as diethylene glycol bis(allyl carbonate), which monomer is sold under the trademark CR-39 by PPG Industries, Inc; polyurea-polyurethane (polyurea urethane) polymers, which are prepared, for example, by the reaction of a polyurethane prepolymer and a diamine curing agent, a composition for one such polymer being sold under the trademark TRIVEX by PPG Industries, Inc; polyol(meth)acryloyl terminated carbonate monomer; diethylene glycol dimethacrylate monomers; ethoxylated phenol methacrylate monomers; diisopropenyl benzene monomers; ethoxylated trimethylol propane triacrylate monomers; ethylene glycol bismethacrylate monomers; poly(ethylene glycol) bismethacrylate monomers; urethane acrylate monomers; poly(ethoxylated bisphenol A dimethacrylate); poly(vinyl acetate); poly(vinyl alcohol); poly(vinyl chloride); poly(vinylidene chloride); polyethylene; polypropylene; polyurethanes; polythiourethanes; thermoplastic polycarbonates, such as the carbonate-linked resin derived from bisphenol A and phosgene, one such material being sold under the trademark LEXAN; polyesters, such as the material sold under the trademark MYLAR; poly(ethylene terephthalate); polyvinyl butyral; poly(methyl methacrylate), such as the material sold under the trademark PLEXIGLAS, and polymers prepared by reacting polyfunctional isocyanate(s) and/or isothiocyanate(s) with polythiol(s) or polyepisulfide monomer(s), either homopolymerized or co- and/or terpolymerized with polythiols, polyisocyanates, polyisothiocyanates and optionally ethylenically unsaturated monomers or halogenated aromatic-containing vinyl monomers. Also contemplated are copolymers of such monomers and blends of the described polymers and copolymers with other polymers, e.g., to form interpenetrating network products. The exact nature of the organic substrate is not critical to the present invention. However, the organic polymeric substrate should be chemically compatible with the photochromic polymeric coating superposed on, e.g., applied to, the surface of the substrate. For optical applications, the substrate should be transparent, more desirably optically clear.

The polymeric organic substrate used to prepare the photochromic articles of the present invention can have a protective coating, e.g., an abrasion resistant coating, on its surface. For example, commercially available thermoplastic polycarbonate optical lenses are typically sold with an abrasion-resistant coating, e.g., a hard coating, already applied to its surface(s) because the surface tends to be readily scratched, abraded or scuffed. An example of such an article is the Gentex polycarbonate lens (available from Gentex Optics) that is sold with a hard coating already applied to the polycarbonate surface. As used in this disclosure and claims, the terms “polymeric organic substrate” (or terms of similar import) or “surface” of such a substrate, is intended to mean and include either the polymeric organic substrate itself or such a substrate with a coating, e.g., protective coating and/or primer, on the substrate. Thus, when reference is made in this disclosure or claims to applying a primer coating or photochromic polymeric coating to the surface of the substrate, such reference includes applying such a coating to the polymeric organic substrate per se or to a coating, e.g., an abrasion-resistant coating or primer, on the surface of the substrate. Hence, the term “substrate” includes substrates having a protective and/or primer coating on its surface. The coating can be any suitable coating (other than a photochromic coating) and is not limited to an abrasion-resistant coating (hard coat), e.g., any protective coating, primer coating, or even a coating that provides additional functional properties to the article of which the substrate is a part.

The use of photochromic organic coatings on plastic substrates, particularly plastic substrates such as thermoplastic polycarbonates, has been described. Any organic polymeric material that is compatible with the chosen organic substrate and which will function as a host material for the organic photochromic materials or compounds chosen for use can be used as the material for the photochromic coating. Desirably, the host organic polymeric coating has sufficient internal free volume for the photochromic material to function efficiently, e.g., to change from a colorless form to a colored form that is visible to the naked eye in response to ultraviolet (UV) radiation, and to change back to the colorless form when the UV radiation is removed. Otherwise, the precise chemical nature of the organic coating that is used as the host material for the photochromic material(s) is not critical.

Non-limiting examples of such organic polymeric materials include polyurethane-based coatings, such as those described in U.S. Pat. Nos. 6,107,395 and 6,187,444 B1, and International Publication WO 01/55269; epoxy resin-based coatings, such as those described in U.S. Pat. No. 6,268,055 B1; acrylic/methacrylic monomer-based coatings, such as those described in U.S Pat. No. 6,602,603, nternational Patent Publications WO 96/37593 and WO 97/06944, and U.S. Pat. Nos. 5,621,017 and 5,776,376; aminoplast, e.g., melamine type, resins, such as those described in U.S Pat. Nos. 6,506,488 B1 and 6,43,544 B1; coatings comprising hydroxyl-functional components and polymeric anhydride-functional components, e.g., polyanhydride coatings, such as those described in U.S Pat. No. 6,436,525 B1; polyurea urethane coatings such as those described in column 2, line 27 to column 1B, line 67 of U.S. Pat. No. 6,531,076 B2; and coatings comprising N-alkoxymethyl(meth)acrylamide functional polymers, such as those described in U.S. Pat. No. 6,060,001.

Of particular interest are photochromic polyurethane-based coatings, photochromic polyacrylic or polymethacrylic-based coatings [referred to collectively herein as poly(meth)acrylic-based coatings], polyurea urethane-based coatings, aminoplast resin-based coatings and photochromic epoxy resin-based coatings. Of special interest are the optically clear photochromic polyurethane, polyurea urethane, epoxy and poly(meth)acrylic-based coatings for use on transparent, e.g., optically clear, plastic substrates for ophthalmic applications, such as piano and vision correcting lenses, sun lenses and goggles, commercial and residential windows, automotive and aircraft transparencies, helmets, plastic sheeting, clear films, etc.

The term “transparent”, as used in this disclosure and claims in connection with a substrate, film or coating, is intended to mean that the indicated coating, film or material, such as the plastic substrate, the non-activated photochromic polymeric coating, the polymeric tie layer, and coatings superimposed or superposed on the photochromic polymeric coating or polymeric tie layer, have a light transmission of at least 70%, desirably at least 80%, and more desirably at least 85%. By the term “optically clear”, as used in this disclosure and claims, is meant that the specified item has a light transmission that satisfies commercially accepted and regulatory values for optical, e.g., ophthalmic, articles.

Polyurethanes that can be used to prepare a photochromic polyurethane coating are those produced by the reaction of an organic polyol component and an isocyanate component, as more fully described in column 3, line 4 through column 6, line 22 of U.S. Pat. No. 6,187,444 B1. More particularly, the polyurethanes are produced from a combination of at least one hard segment producing organic polyol and at least one soft segment producing organic polyol. Generally, the hard segment results from the reaction of the isocyanate and a chain extender, e.g., a short chain polyol such as low molecular weight diols and triols; and the soft segment results from the reaction of the isocyanate with a polymer backbone component such as a polycarbonate polyol, a polyester polyol or a polyether polyol, or mixtures of such polyols. The weight ratio of hard segment producing polyols to soft segment-producing polyols can vary from 10:90 to 90:10.

The relative amounts of the components comprising the polyurethane reaction mixture can be expressed as a ratio of the available number of reactive isocyanate groups to the available number of reactive hydroxyl groups, e.g., a ratio of NCO:OH groups of from 0.3:1.0 to 3.0:1.0. The isocyanate component can be an aliphatic, aromatic, cycloaliphatic or heterocyclic isocyanate, or mixtures of such isocyanates. Typically, the isocyanate component is chosen from blocked or unblocked aliphatic or cycloaliphatic isocyanates, or mixtures of such isocyanates.

As further described in U.S. Pat. No. 6,107,395, polyurethanes suitable as a photochromic host material can be prepared from an isocyanate reactive mixture comprising (i) from 40 to 85 weight percent of one or more polyols having a nominal functionality of from 2 to 4 and molecular weights of from 500 to 6000 g/mole, (ii) from 15 to 60 weight percent of one or more diols or triols or mixtures thereof having a functionality of from 2 to 3 and molecular weights of from 62 to 499, and (iii) an aliphatic polyisocyanate having a functionality of less than 3, e.g., 2.

The previously mentioned U.S Pat. No. 6,602,603 describes reaction mixtures for poly(meth)acrylic host materials for photochromic materials as comprising at least two difunctional (meth)acrylate monomers, which can have from greater than 3 to less than 15 alkoxy units. In one described embodiment, a difunctional (meth)acrylate has the reactive acrylate groups connected by a straight or branched chain alkylene group, which usually contains from 1 to 8 carbon atoms; while a second difunctional (meth)acrylate has the reactive acrylate groups connected by ethylene oxide, propylene oxide, butylene oxide or mixtures of such oxide groups in random or block order.

Epoxy resin-based coatings described in U.S. Pat. No. 6,268,055 B1 are those prepared by the reaction of a composition comprising an epoxy resin or polyepoxide, e.g., polyglycidyl ethers of aliphatic alcohols and phenols, epoxy-containing acrylic polymers, polyglycidyl esters of polycarboxylic acids and mixtures of such epoxy-containing materials, with a curing agent, e.g., a polyacid comprising a half-ester formed from reacting an acid anhydride with an organic polyol.

Aminoplast resin-based coatings are described in U.S. Pat. Nos. 6,432,544 B1 and 6,506,488. These coatings are the reaction product of material(s) having at least two different functional groups chosen from hydroxyl, carbamate, urea or mixtures of such functional groups, and an aminoplast resin, e.g., a crosslinking agent. Materials having at least two different functional groups are described in the '444 patent from column 3, line 40 through column 12, line 23, and in the preceding disclosure with respect to the aminoplast tie layer. The aminoplast resin is a condensation product of an amine or amide with an aldehyde, e.g., formaldehyde, acetaldehyde, crotonaldehyde, benzaldehyde and furfural. The amine or amide can be melamine, benzoguanamine, glycoluril, urea and similar compounds, Melamine is typically used. Typically, the aminoplast resin has at least two reactive groups. Non-limiting examples of aminoplast resins are described in the '444 patent in column 12, lines 49 to 67.

The amount of photochromic polymeric coating applied to at least one surface of the plastic substrate is an amount that is sufficient to provide a sufficient quantity of organic photochromic material, which produces a coating that exhibits a desired change in optical density (ΔOD) when the cured coating is exposed to ultraviolet (UV) radiation, e.g., a photochromic amount. Desirably, the change in optical density measured at 22° C. (72° F.) after 30 seconds of UV exposure is at least 0.05, more desirably at least 0.15, and still more desirably at least 0.20. The change in optical density after 15 minutes of UV exposure is at least 0.10, more desirably at least 0.50, and still more desirably at least 0.70.

Stated differently, the amount of active photochromic material used in the photochromic coating can range from 0.5 to 40.0 weight percent, based on the total weight of monomer(s)/resin(s) used to produce the coating. The relative amounts of photochromic material(s) used will vary and depend in part upon the relative intensities of the color of the activated form of the photochromic compound(s), the ultimate color desired, and the solubility or dispersibility of the photochromic material(s) in the polymeric coating. Care should be taken to avoid use of amounts of photochromic material, which cause crystals of the photochromic material(s) to be formed within the coating. Desirably, the concentration of active photochromic material(s) within the photochromic coating ranges from 1.0 to 30 weight percent, more desirably, from 3 to 20 weight percent, and most desirably, from 3 to 10 weight percent (based on the total weight of monomer(s) used to produce the coating.) The amount of photochromic material in the coating can range between any combinations of these values, inclusive of the recited values.

The bleach rate of the photochromic coating, as reported in terms of the fading half-life (T 1/2), is not more than 500 seconds, more desirably not more than 190 seconds, and still more desirably not more than 115 seconds. The half-life bleach rate is the time interval in seconds for the change in optical density (ΔOD) of the activated form of the photochromic coating to reach one half the highest ΔOD after removal of the source of activating light. The aforedescribed values for change in optical density and bleach rate are measured at 22° C. (72° F.).

The photochromic coating applied to the surface of the plastic substrate will typically have a thickness of at least 3 microns, desirably at least 5 microns, more desirably, at least 10 microns, e.g., 20 or 30 microns. The applied photochromic coating will also usually have a thickness of not more than 200 microns, desirably not more than 100 microns, and more desirably not more than 50 microns, e.g., 40 microns. The thickness of the photochromic coating can range between any combinations of these values, inclusive of the recited values. For example, the photochromic coating can range from 10 to 50 microns, e.g., 20 to 40 microns. Desirably the applied photochromic coating is free of cosmetic defects, such as scratches, pits, spots, cracks, inclusions, etc.

Typically, the term “coating” is considered by those knowledgeable in the coating art to be a layer having a thickness of not more than 4 mils (about 100 microns). However, as used in this specification and claims in relation to the photochromic coating, the term coating is defined herein as having a thickness such as a thickness defined hereinabove. Further, as used in this specification and claims, it is intended that the term “surface of the polymeric substrate” or like terms, e.g., the surface to which the photochromic polymeric coating is applied, include the embodiment in which only at least a portion of the surface of the substrate is coated. Hence, the photochromic coating (and the polymeric tie layer that can be applied to the photochromic coating) can cover only a portion of a surface of the substrate, but typically it is applied to the entire surface of at least one surface.

The hardness of the photochromic coating is not critical, but after application and curing, should desirably be hard enough to be physically/mechanically handled without causing blemishes, e.g., scratches, in the coating. The hardness of the photochromic coating desirably is less than the radiation-cured acrylate-based film applied to the photochromic coating, which in turn is desirably softer than the abrasion-resistant (hard coat) coating applied to the radiation-cured acrylate-based film. Thus, the principal coatings applied to the plastic substrate (not including any primer layer that can be applied to the substrate) increase in hardness in the direction of the abrasion-resistant coating. The hardness of coatings or films can be quantified by tests known to the skilled artisan, e.g., Fischer microhardness, pencil hardness or Knoop hardness.

The Fischer microhardness of the photochromic polymeric coatings is typically less than 30 Newtons per mm², more particularly, less than 25, e.g., less than 15, such as 2 or 5, Newtons per mm^{2.} In particular, the Fischer microhardness values will be in the lower portion of the ranges described herein, e.g., from 2 to 25, such as 10 to 15, e.g., 12 Newtons per mm^{2.} The lower range of hardness allows the electrocyclic mechanism discussed previously in relation to photochromic materials to occur with greater efficiency than at higher hardness values. The Fischer microhardness of the photochromic polymeric coatings can range between any combination of the stated values, inclusive of the recited values. Fischer microhardness values can be obtained with a Fischerscope HCV Model H-100 (available from Fischer Technology, Inc.) by taking 3 measurements in the center area of the test sample under conditions of a 100 milliNewton load, 30 load steps, and 0.5 second pauses between load steps at an indentor (Vickers diamond stylus)depth of 2 um(microns).

Photochromic materials, e.g., dyes/compounds or compositions containing such dye/compounds, that can be utilized for the photochromic coating applied to the substrate are inorganic and/or organic photochromic compounds and/or substances containing such organic photochromic compounds that are currently known to those skilled in the art or that are later discovered. The particular photochromic material(s), e.g., compound(s), chosen is not critical, and its/their selection will depend on the ultimate application and the color or hue desired for that application. When two or more photochromic compounds are used in combination, they are generally chosen to complement one another to produce a desired color or hue.

Organic photochromic compounds used in the photochromic coating commonly have at least one activated absorption maxima within the visible spectrum of between 300 and 1000, e.g., between 400 and 700, nanometers. The organic photochromic material(s) is incorporated, e.g., dissolved or dispersed, in the photochromic coating, and color when activated, e.g., when exposed to ultraviolet radiation, the photochromic material(s) changes to the color or hue that is characteristic of the colored form of such material(s).

The inorganic photochromic material typically contains crystallites of silver halide, cadmium halide and/or copper halide. Generally, the halide material is the chloride and bromide. Other inorganic photochromic materials can be prepared by the addition of europium (II) and/or cerium (III) to a mineral glass, such as a soda-silica glass. In one embodiment, the inorganic photochromic material(s) are added to molten glass and formed into particles that are incorporated into the coating composition that is used to form the polymeric photochromic coating. Such inorganic photochromic materials are described in the Kirk Othmer Encyclopedia of Chemical Technology, 4th Edition, Volume 6, pages 322 to 325.

In one contemplated embodiment, the organic photochromic component of the photochromic coating comprises:
(a) at least one photochromic organic compound having a visible lambda max of from 400 to less than 550, e.g., from 400 to 525, nanometers; and
(b) at least one photochromic organic compound having a visible lambda max of greater than 525 or 550 nanometers, e.g., from 525 or 550 to 700 nanometers.

Non-limiting examples of photochromic compounds that can be used in the photochromic coating include benzopyrans, naphthopyrans, e.g., naphtho[1,2-b]pyrans, naphtho[2,1-b]pyrans, spiro-9-fluoreno[1,2-b]pyrans, phenanthropyrans, quinopyrans, and indeno-fused naphthopyrans, such as those disclosed in U.S. Pat. No. 5,645,767 at column 1, line 10 to column 12, line 57 and in U.S. Pat. No. 5,658,501 at column 1, line 64 to column 13, line 36. Additional non-limiting examples of photochromic compounds that can be used include oxazines, such as benzoxazines, naphthoxazines, and spiro(indoline)pyridobenzoxazines. Other photochromic substances contemplated for use herein are photochromic metal dithizonates, e.g., mercury dithizonates, which are described in, for example, U.S. Pat. No. 3,361,706; fulgides and fulgimides, e.g. the 3-furyl and 3-thienyl fulgides and fulgimides, which are described in U.S. Pat. No. 4,931,220 at column 20, line 5 through column 21, line 38; diarylethenes, which are described in U.S. Patent Application 2003/0174560 from paragraph [0025] to [0086]; and mixtures of any of the aforementioned photochromic materials/compounds.

Further non-limiting examples of photochromic compounds, polymerizable photochromic compounds and complementary photochromic compounds are described in the following U.S. patents:

U.S. Pat. No. 5,166,345 at column 3, line 36 to column 14, line 3;

U.S. Pat. No. 5,236,958 at column 1, line 45 to column 6, line 65;

U.S. Pat. No. 5,252,742 at column 1, line 45 to column 6, line 65;

U.S. Pat. No. 5,359,085 at column 5, line 25 to column 19, line 55;

U.S. Pat. No. 5,488,119 at column 1, line 29 to column 7, line 65;

U.S. Pat. No. 5,821,287 at column 3, line 5 to column 11, line 39;

U.S. Pat. No. 6,113,814 at column 2, line 23 to column 23, line 29;

U.S. Pat. No. 6,153,126 at column 2, line 18 to column 8, line 60;

U.S. Pat. No. 6,296,785 at column 2, line 47 to column 31, line 5;

U.S. Pat. No. 6,348,604 at column 3, line 26 to column 17, line 15; and

U.S. Pat. No.6,353,102 at column 1, line 62 to column 11, line 64.

Spiro(indoline)pyrans are also described in the text, Techniques in Chemistry, Volume III, “Photochromism”, Chapter 3, Glenn H. Brown, Editor, John Wiley and Sons, Inc., New York, 1971. In addition, it is contemplated that organic photochromic materials such as photochromic pigments and photochromic compounds encapsulated in metal oxides can be used in the photochromic coating. See, for example, the materials described in U.S. Pat. Nos. 4,166,043 and 4,367,170.

The photochromic coating can contain one photochromic compound or a mixture of two or more photochromic compounds, as desired. Mixtures of photochromic compounds can be used to attain certain activated colors such as a near neutral gray or near neutral brown. See, for example, U.S. Pat. No. 5,645,767, column 12, line 66 to column 13, line 19, which describes the parameters that define neutral gray and brown colors.

The photochromic compound(s) described herein can be incorporated into the curable coating composition by addition to the coating composition and/or by dissolving it in a solvent before adding it to the curable coating composition. Alternatively, although less preferred, the photochromic compound(s) can be incorporated into the cured polymer coating by imbibition, permeation, diffusion or other transfer methods, which methods are known to those skilled in the art of dye transfer into host materials.

In addition to photochromic materials, the photochromic coating (or precursor formulation) can contain additional conventional adjuvants that impart desired properties or characteristics to the coating, or which are required by the process used to apply and cure the photochromic coating on the surface of the plastic substrate, or which enhance the performance of the coating. Non-limiting examples of such adjuvants include ultraviolet light absorbers, light stabilizers, such as hindered amine light stabilizers (HALS), asymmetric diaryloxalamide (oxanilide) compounds, singlet oxygen quenchers, e.g., a nickel ion complex with an organic ligand, antioxidants, e.g., polyphenolic antioxidants, heat stabilizers, rheology control agents, leveling agents, e.g., surfactants, free radical scavengers and adhesion promoting agents, such as trialkoxysilanes, e.g., silanes having an alkoxy radical of 1 to 4 carbon atoms, including γ-glycidoxypropyl trimethoxy silane, γ-aminopropyl trimethoxysilane, 3,4-epoxy cyclohexylethyl trimethoxysilane, dimethyldiethoxysilane, aminoethyl trimethoxysilane, and 3-(trimethoxysilyl)propyl methacrylate. Mixtures of such photochromic performance enhancing adjuvant materials are also contemplated. See, for example, the materials described in U.S. Pat. Nos. 4,720,356, 5,391,327 and 5,770,115.

Compatible (chemically and color-wise) tints, e.g., dyes, can be added to the photochromic coating formulation or applied to the plastic substrate for medical reasons or for reasons of fashion, e.g., to achieve a more aesthetic result. The particular dye chosen can vary and will depend on the aforesaid need and result to be achieved. In one embodiment, the dye can be chosen to complement the color resulting from the activated photochromic materials used, e.g., to achieve a more neutral color or absorb a particular wavelength or incident light. In another contemplated embodiment, the dye can be chosen to provide a desired hue to the substrate and/or coating when the photochromic coating is in an inactivated state.

The photochromic coating composition can be applied to the surface of the substrate, e.g., the plastic substrate, as a polymerizable formulation and then cured (polymerized) by methods well known to those skilled in the art including, but not limited to, photopolymerization, thermal polymerization (including infrared polymerization), and other sources of radiation. Such application methods include the art-recognized methods of spin coating, curtain coating, dip coating, spray coating or by methods used in preparing overlays. Such methods are described in U.S. Pat. No. 4,873,029.

When applied as a polymerizable formulation, the photochromic coating formulation will also typically contain from 0 to 10 weight percent, e.g., from 0.01 to 8 weight percent, desirably from 0.1 to 5 weight percent, based on the total weight of the polymerizable monomer(s) in the formulation, of at least one catalyst and/or polymerization initiator, including photoinitiators. The amount of catalyst/initiator can range between any combinations of the aforestated values, inclusive of the recited values. The catalyst(s)/initiator(s) will be chosen from those materials that can be used to polymerize the particular monomer(s) used to produce the polymeric coating chosen as the photochromic host, and that will not be significantly detrimental to the photochromic materials that can be included in the coating formulation. The amount of catalyst/polymerization initiator(s) used to polymerize the polymerizable components of the photochromic coating formulation can vary and will depend on the particular initiator and the polymerizable monomers used. Typically, only that amount that is required to initiate (catalyze) and sustain the polymerization reaction is required, e.g., an initiating or catalytic amount.

For example, catalysts that can be used to cure polyurethane reaction mixtures can be chosen from Lewis bases, Lewis acids and insertion catalysts described in Ullmann's Encyclopedia of Industrial Chemistry, 5^{th} Edition, 1992, Volume A21, pp. 673 to 674. Usually the catalyst is an organo tin catalyst, e.g., tin octylate, dibutyl tin dilaurate, dibutyl tin diacetate, dibutyl tin mercaptide, dibutyl tin dimaleate, dimethyl tin diacetate, dimethyl tin dilaurate and 1,4-diazabicyclo[2.2.2]octane. Mixtures of tin catalysts can be used. Other tin catalysts described in the art can be used as well.

Epoxy resin coating compositions typically contain a polyacid curing agent having a high average acid functionality, e.g., two or more acid groups per molecule. Desirably, the acid group is a carboxylic acid group. Examples of polycarboxylic acids include dicarboxylic acids such as oxalic, malonic, succinic, tartaric, glutaric, adipic, sebacic, maleic, fumaric, phthalic, isophthalic, terephthalic, and dodecanedioc acids; tricarboxylic acids such as citric acid; and tetracarboxylic acids such as 1,2,3,4-butane tetracarboxylic acid.

Polyanhydride coating compositions typically contain an amine compound as the curing catalyst. Examples of amine compounds include dimethyl cocoamine, dimethyl dodecylamine, triethylamine, triethanolamine and phenolic compounds containing at least two dialklyamino groups. Aminoplast resin and alkoxyacrylamide polymer coating compositions commonly contain an acidic material as a catalyst. Examples include phosphoric acid or substituted phosphoric acids, such as alkyl acid phosphate and phenyl acid phosphate; and sulfonic acids or substituted sulfonic acids, such as para-toluene sulfonic acid, dodecylbenzene sulfonic acid and dinonylnaphthalene sulfonic acid.

Acrylic/methacrylic monomer-based coating compositions can contain thermal initiators, e.g., initiators that produce free radicals, such as organic peroxy compounds or azobis(organonitrile) compounds, photoinitiators or mixtures of such initiators.

Non-limiting examples of suitable organic peroxy compounds include peroxymonocarbonate esters, such as tertiarybutylperoxy isopropyl carbonate; peroxydicarbonate esters, such as di(2-ethylhexyl) peroxydicarbonate, di(secondary butyl) peroxydicarbonate and diisopropyl peroxydicarbonate; diacyl peroxides, such as 2,4-dichlorobenzoyl peroxide, isobutyryl peroxide, decanoyl peroxide, lauroyl peroxide, propionyl peroxide, acetyl peroxide, benzoyl peroxide, p-chlorobenzoyl peroxide; peroxyesters, such as t-butylperoxy pivalate, t-butylperoxy octylate, and t-butylperoxy isobutyrate; methylethylketone peroxide; and acetylcyclohexane sulfonyl peroxide.

Non-limiting examples of suitable azobis(organonitrile) compounds include azobis(isobutyronitrile), 2,2′-azobis(2,4-dimethylpentanenitrile), 1,1′-azobiscyclohexanecarbonitrile, and azobis(2,4-dimethylvaleronitrile) and mixtures of such azo thermal initiators. Preferred thermal initiators are those that do not discolor the resulting coating or decompose the photochromic material incorporated within the polymerizable coating composition.

Photopolymerization can be performed in the presence of at least one photoinitiator using ultraviolet light and/or visible light. Photoinitiators, which are free radical initiators, are classified in two major groups based upon their mode of action. Cleavage-type photoinitiators include, but are not limited to, acetophenones, α-aminoalkylphenones, benzoin ethers, benzoyl oximes, acylphosphine oxides and bisacylphosphine oxides. Abstraction-type photoinitiators include, but are not limited to, benzophenone, Michler's ketone, thioxanthone, anthraquinone, camphorquinone, fluorone and ketocoumarin. Abstraction-type photoinitiators function better in the presence of materials such as amines and other hydrogen donor materials added to provide labile hydrogen atoms for abstraction. Typical hydrogen donors have an active hydrogen positioned alpha to an oxygen or nitrogen, e.g., alcohols, ethers and tertiary amines, or an active hydrogen atom directly attached to sulfur, e.g., thiols. In the absence of such added materials, photoinitiation can still occur via hydrogen abstraction from monomers, oligomers or other components of the system.

Non-limiting examples of photopolymerization initiators which can be used include benzil, benzoin, benzoin methyl ether, benzoin isobutyl ether, benzophenol, acetophenone, benzophenone, 4,4′-dichlorobenzophenone, 4,4′-bis(N,N′-dimethylamino) benzophenone, diethoxyacetophenone, fluorones, e.g., the H-Nu series of initiators available from Spectra Group Limited, 2-hydroxy-2-methyl-1-phenylpropan-1-one, 1-hydroxycyclohexyl phenyl ketone, 2-isopropylthixantone, α-aminoalkylphenone, e.g., 2-benzyl-2-dimethylamino-1-(4-morpholinophenyl)-1-butanone, acylphosphine oxides, such as 2,6-dimethylbenzoyl diphenyl phosphine oxide, 2,4,6-trimethylbenzoyl diphenyl phosphine oxide, 2,6-dichlorobenzoyl diphenyl phosphine oxide, and 2,6-dimethoxybenzoyl diphenyl phosphine oxide, bisacylphosphine oxides, such as bis(2,6-dimethyoxybenzoyl)-2,4,4-trimethylepentyl phosphine oxide, bis(2,6-dimethylbenzoyl)-2,4,4-trimethylpentyl phosphine oxide, bis(2,4,6-trimethylbenzoyl)-2,4,4-trimethylpentyl phosphine oxide, and bis(2,6-dichlorobenzoyl)-2,4,4-trimethylpentyl phosphine oxide, phenyl-4-octyloxyphenyliodonium hexafluoroantimonate, dodecyldiphenyliodonium hexafluoroantimonate, (4-(2-tetradecanol)oxyphenyl)-iodonium hexafluoroantimonate and mixtures of such photopolymerization initiators.

The source of radiation used for photopolymerization is desirably chosen from those sources that emit ultraviolet light and/or visible light. The source of radiation can be a mercury lamp, a mercury lamp doped with Fel₃ and/or Gal₃, a germicidal lamp, a xenon lamp, a tungsten lamp, a metal halide lamp or a combination of such lamps. Typically, the absorbance spectra of the photoinitiator(s) is matched with the spectral output of the light source bulb, e.g., an H bulb, D bulb, Q bulb and/or V bulb, for highest curing efficiency. The exposure time of the curable coating to the light source will vary depending upon the wavelength and intensity of the light source, the photoinitiator, and thickness of the coating. Generally, the exposure time will be sufficient to substantially cure the coating, or produce a coating that is cured sufficiently to allow physical handling followed by a post thermal cure. The photochromic coating can also be cured using an electron beam process that does not require the presence of a thermal or photoinitiator.

Solvents can also be present in the coating formulation in order to dissolve and/or disperse the components of the coating formulation. Typically, a solvating amount of solvent is used, e.g., an amount which is sufficient to solubilize/disperse the solid components in the coating formulation. Commonly, from 10 to 80 weight percent of solvent material, based on the total weight of the coating formulation, is used.

Solvents include, but are not limited to, benzene, toluene, methyl ethyl ketone, methyl isobutyl ketone, acetone, ethanol, tetrahydrofurfuryl alcohol, propyl alcohol, propylene carbonate, N-methyl pyrrolidinone, N-vinyl pyrrolidinone, N-acetyl pyrrolidinone, N-hydroxymethyl pyrrolidinone, N-butyl pyrrolidinone, N-ethyl pyrrolidinone, N-(N-octyl)pyrrolidinone, N-(N-dodecyl)pyrrolidinone, 2-methoxyethyl ether, xylene, cyclohexane, 3-methyl cyclohexanone, ethyl acetate, butyl acetate, tetrahydrofuran, methanol, amyl propionate, methyl propionate, propylene glycol methyl ether, diethylene glycol monobutyl ether, dimethyl sulfoxide, dimethyl formamide, ethylene glycol, mono- and di-alkyl ethers of ethylene glycol and their derivatives, which are sold as CELLOSOLVE industrial solvents, and mixtures of such solvents.

In a further contemplated embodiment, the photochromic polymeric coating can be applied as a water-borne coating, e.g., as an aqueous polymer dispersion, such as a latex, with or without the presence of an organic solvent. This type of system is a two-phase system comprising an aqueous phase and an organic phase, which is dispersed in the aqueous phase. Use of water-borne coatings is well known in the art. See, for example, U.S. Pat. No. 5,728,769, which relates to aqueous urethane resins and coatings prepared from such resins, and the patents referred to in the '769 patent.

After the photochromic coating formulation is applied to the surface of the plastic substrate, it is cured (polymerized) by the application of heat (in the case of a thermal cure), and/or ultraviolet or electron beam radiation. The specific cure conditions used will depend on the plastic substrate, the polymerizable components in the formulation and the type of catalyst/initiator used, or in the case of electron beam radiation, the intensity of the electron beam. Thermal curing can involve heating from room temperature up to temperatures below which the plastic substrate is not damaged due to such heating. Temperatures up to 200° C. have been reported. Such cure conditions are well known in the art. For example, a typical thermal cure cycle involves heating the formulation from room temperature (22° C.) to from 85 to 125° C. over a period of from 2 to 20 minutes. The time required for ultraviolet or electron beam radiation cures is generally shorter than a thermal cure, e.g., from 5 seconds to 5 minutes, and will depend on the intensity (power) of the radiation. When the thermal or UV/electron beam cure conditions produce a coating that can be physically handled but is not completely cured, an additional thermal post cure step can also be employed to fully cure the photochromic coating.

Prior to applying the photochromic coating to the surface of the substrate to be covered, the surface of the substrate is often cleaned and treated to provide a clean surface and a surface that will enhance adhesion of the photochromic coating to the substrate. Effective cleaning and treatments commonly used include, but are not limited to, ultrasonic washing, washing with an aqueous soap/detergent solution (or washing with soap and water) followed by rinsing, and cleaning with an aqueous mixture of organic solvent, e.g., a 50:50 mixture of isopropanol/water or ethanol/water, UV treatment, activated gas treatment, e.g., treatment with low temperature plasma or corona discharge (as discussed subsequently herein), and chemical treatment that results in hydroxylation of the substrate surface, e.g., etching of the surface with an aqueous solution of alkali metal hydroxide, e.g., sodium or potassium hydroxide, which solution can also contain a fluorosurfactant. Generally, the alkali metal hydroxide solution is a dilute aqueous solution, e.g., from 5 to 40 weight percent, more typically from 10 to 15 weight percent, such as 12 weight percent, alkali metal hydroxide. See, for example, U.S. Pat. No. 3,971,872, column 3, lines 13 to 25; U.S. Pat. No. 4,904,525, column 6, lines 10 to 48; and U.S. Pat. No. 5,104,692, column 13, lines 10 to 59, which describe surface treatments of polymeric organic materials.

In some cases, a primer coating is applied to the plastic surface substrate before application of the photochromic coating. The primer coating is interposed between the organic substrate and the photochromic polymeric coating, and serves as a barrier coating to prevent interaction of the components comprising the photochromic polymeric coating with the substrate and vice versa, and/or as an adhesive layer to promote adhesion of the photochromic coating to the plastic substrate. The primer can be applied to the plastic substrate by any of the methods used to apply the photochromic coating, e.g., spray, spin, spread, curtain, roll or dip coating; and can be applied to a cleaned and untreated or cleaned and treated, e.g., chemically treated, surface of the substrate. Primer coatings are well known to those skilled in the art. Selection of an appropriate primer coating will depend on the plastic substrate used and the particular photochromic coating, e.g., the primer coating must be chemically and physically compatible with the surface of the plastic substrate and the photochromic coating, while providing the functional benefits desired for the primer coating, e.g., barrier and adhesive properties.

The primer coating can be one or several monomolecular layers thick, and can range from 0.1 to 10 microns, more usually from 0.1 to 2 or 3 microns. The thickness of the primer can vary between any combination of the aforementioned values, inclusive of the recited values. One contemplated embodiment of a suitable primer coating comprises an organofunctional silane, such as methacryloxypropyl trimethoxysilane, a catalyst of a material that generates acid on exposure to actinic radiation, e.g., onium salts, and an organic solvent, such as diglyme or isopropyl alcohol, as described in U.S. Pat. No. 6,150,430. A further example of a primer coating is described in U.S. Pat. No. 6,025,026, which describes a composition that is substantially free of organosiloxanes and which comprises organic anhydrides having at least one ethylenic linkage and an isocyanate-containing material.

In a further contemplated embodiment, an abrasion resistant coating is superposed, e.g., appended to, the photochromic polymeric coating. Alternatively, a second transparent polymeric layer coating or film, which is typically not photochromic, is superposed, e.g., superimposed on, the photochromic polymeric coating. The second transparent polymeric layer can have the abrasion resistant layer or other functional polymeric layers appended to it. The second polymeric layer should be, as stated, transparent, e.g., optically clear, and not substantially interfere with the optical properties of an optical, e.g., ophthalmic, photochromic article prepared with the second transparent polymeric layer. Further, the second polymeric layer is desirably resistant to dilute aqueous inorganic caustic solutions, e.g., aqueous sodium and potassium hydroxide solutions, and is compatible with an abrasion resistant coating (if used) applied to the surface of the second polymeric layer.

The precise chemical nature of the second polymeric layer is not critical, with the proviso that it be transparent, e.g., optically clear. Any curable polymeric material that, when cured, is transparent and ties together the photochromic polymeric layer and a superimposed functional layer, e.g., the abrasion resistant coating or other film/coating that provides additional features, without adversely affecting the function of the functional layers that it ties together, can be used as a tie layer. Other film/coatings that provide additional features include, but are not limited to, antireflective coatings, antistatic coatings, water repellant coatings and combinations of such coatings. A suitable tie layer is described in International Patent Application WO 03/058300. The tie layer described in said International Patent Application is a radiation cured acrylate-based tie layer and is described therein as being (a) scratch resistant, (b) resistant to treatment with dilute aqueous inorganic caustic solutions, and (c) compatible with abrasion resistant, organo silane-containing coatings.

Other materials that can be used as the second transparent polymeric layer (tie layer) include, but are not limited to, (1) dendritic polyester acrylate-based coating layers, as described in U.S. patent application Ser. No. ______ of E. King, which has been filed on the same date as the present application and is entitled “Photochromic Optical Article”; (2) cured coating layers prepared from compositions comprising a maleimide derivative, as described in U.S. patent application Ser. No. ______ of E. King, which has been filed on the same date as the present application and is entitled “Photochromic Optical Article”; (3) thermally cured, acrylic-based coatings; and (4) thermally cured, crosslinkable thermosetting coating compositions, such as polyurethane-based coatings, polyepoxide-based coatings, aminoplast-based coatings, polysiloxane-based coatings, carbamate and/or urea-based coatings, film-forming resin compositions comprising a latex emulsion that includes cross-linked polymeric microparticles dispersed in an aqueous continuous phase, and powder clear coatings, all as described in U.S. patent application Ser. No. ______ of C. Knox et al, which has been filed on the same date as the present application and is entitled “Photochromic Optical Article”.

An acrylic-based tie layer, such as the film described in WO 03/058300 A1, can be prepared using acrylic or methacrylic monomers or a mixture of acrylic and/or methacrylic monomers (hereinafter referred to collectively as (meth)acrylic monomers). The mixture of (meth)acrylic monomers can include mono-, di-, tri-, tetra-, and penta-acrylic functional monomers. Additional co-polymerizable monomers, such as epoxy monomers, e.g., monomers containing an epoxy functionality, monomers containing both acrylic and epoxy functionalities, etc., can also be present in the formulation used to prepare the acrylate-based film, as described subsequently herein. The monomers used to prepare the acrylate-based film are typically comprised of a plurality, e.g., a major amount, e.g., more than 50 weight percent, of acrylic-functional monomers; hence the designation “acrylate-based film”. The formulations used to prepare the acrylate-based film can also contain components having at least one isocyanate functionality, e.g., organic monoisocyanates and organic diisocyanates, thereby to incorporate polyurethane groups into the film.

As used herein, the terms “acrylic” and “acrylate” are used interchangeably (unless to do so would alter the intended meaning) and include derivatives of acrylic acids, as well as substituted acrylic acids such as methacrylic acid, ethacrylic acid, etc., unless clearly indicated otherwise. The terms “(meth)acrylic” or “(meth)acrylate” are intended to cover both the acrylic/acrylate and methacrylic/methacrylate forms of the indicated material, e.g., monomer. Since, the second transparent polymeric layer is interposed between the photochromic coating and the abrasion-resistant coating, it serves to tie together these coatings and serves as a barrier to protect the photochromic coating.

Radiation-curable and thermally-curable acrylic-based polymeric systems are well known in the polymeric art and any such system that meets the requirements described elsewhere herein for the photochromic article of the present invention can be used to produce the acrylate-based tie layer film. A contemplated embodiment of the radiation-curable composition for the acrylate-based tie layer film comprises a combination or miscible blend of one or more free-radical initiated acrylate monomers and/or acrylate oligomers, and one or more cationic initiated epoxy monomers. When this blend of monomers is cured, a polymerizate comprising an interpenetrating network of polymer components is produced.

Non-limiting examples of acrylic monomers include polyfunctional acrylates, e.g., di-, tri-, tetra-, and penta-functional acrylates, and monofunctional acrylates, e.g., a monomer containing a single acrylic functionality, hydroxy-substituted monoacrylates and alkoxysilyl alkylacrylates, such as trialkoxysilylpropylmethacrylate. Other reactive monomers/diluents, such as monomers containing an ethylenic functional group (other than the acrylic-functional materials) can also be present.

Many acrylates can be represented by the following general formula IX,
R—(OC(O)C(R¹)═CH₂)ₙ IX
wherein R is an aliphatic or aromatic group containing from 2 to 20 carbon atoms and optionally from 1 to 20 alkyleneoxy linkages; R′ is hydrogen or an alkyl group containing from 1 to 4 carbon atoms, and n is an integer of 1 to 5. When n is greater than 1, R is a linking group that links the acrylic functional groups together. Typically, R′ is hydrogen or methyl, and n is an integer of from 1 to 3. More specifically, diacrylates (when n is 2) can be represented by general formula X, 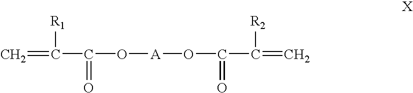
wherein R₁ and R₂ can be the same or different and are each chosen from hydrogen or alkyl groups containing from 1 to 4 carbon atoms, typically hydrogen or methyl, and A is a hydrocarbyl linking group of, for example, from 1 to 20 carbon atoms, e.g., an alkylene group, one or more oxyalkylene group(s) [or mixture of different oxyalkylene groups]; or a group of the following general formula XI, 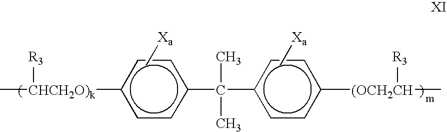
wherein each R₃ is a hydrogen atom or an alkyl group of from 1 to 4 carbon atoms, e.g., methyl; X is a halogen atom, e.g., chlorine; a is an integer of from 0 to 4, e.g., 0 to 1, representing the number of halogen atoms substituted on the benzene ring; and k and m are numbers of from 0 to 20, e.g., 1 to 15, or 2 to 10. The values of k and m are average numbers and when calculated can be a whole number or a fractional number.

Acrylates having an epoxy group can be represented by the following general formula XII, 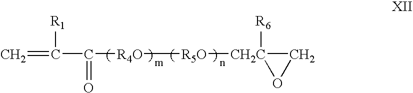
wherein R₁ and R₆ can be the same or different and are each chosen from hydrogen or an alkyl group of from 1 to 4 carbon atoms, e.g., methyl; R₄ and R₅ are alkylene groups containing from 2 to 3 carbon atoms, e.g., ethyleneoxy and propyleneoxy, and m and n are numbers of from 0 to 20, e.g., 0 or 1 to 15 or 2 to 10. When one of m and n is 0 and the other is 1, the remaining R group can be an aromatic group of the following formula XIII, 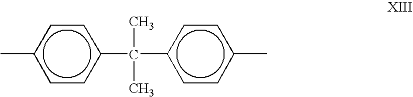
e.g., a group derived from the 2,2′-diphenylenepropane radical, which phenyl groups can be substituted with C₁ to C₄ alkyl groups or halogens, e.g., methyl and/or chlorine.

The amount, number and type of functional acrylates comprising the curable acrylic-based tie layer film formulation will vary and will depend on the physical properties of the film that are most desired since, for example, varying the crosslink density of the film, e.g., by varying the amount of tri-functional acrylates or other cross-linking monomers used in the acrylate-based tie layer film formulation, will alter the final properties of the film. It is generally accepted that the cross-link density of the cured film is a function of the amount of multifunctional acrylates used. High amounts of multifunctional acrylates lead to high hardness, tensile strength and chemical resistance, but with poorer adhesion to the substrate. In contrast, reducing the amount of multifunctional acrylates and increasing the amount of monofunctional acrylates lead to a lower cross-link density of the cured film with consequent lower hardness, chemical resistance and tensile strength, and a slower cure speed. Therefore, one skilled in the art can vary the amounts of mono- and multi-functional acrylate monomers used depending on whether it is desirable to optimize adhesion to the polymeric coating, hardness (scratch resistance), chemical resistance, e.g., resistance to aqueous alkali metal hydroxide treatment, or other properties; or whether it is desirable to compromise one or more of these properties to obtain an average benefit for all of those physical properties. One skilled in the art can readily select the combination of monomeric materials to be used for the acrylate-based tie layer film based on the art-recognized benefits that certain functional groups provide to a radiation-cured acrylate film, and the tests described in this specification that measure the desired physical properties.

In a further contemplated embodiment, the acrylate-based tie layer is prepared from a composition comprising a mixture of free-radical initiated acrylate monomer(s) and cationic initiated epoxy monomer(s). The curable composition can comprise from 10 to 85 percent by weight of at least one epoxy monomer(s) and from 90 to 15 percent by weight of at least one acrylate monomer(s), more typically, from 30 to 70 weight percent epoxy monomer(s) and from 70 to 30 weight percent acrylate monomer(s), and desirably from 35 to 50 weight percent epoxy monomer(s) and from 65 to 50 weight percent acrylate monomers. Monomers containing both epoxy and acrylic functionality are categorized herein as acrylate monomers. The range of acrylate monomers and epoxy monomers in the curable composition described heretofore can vary between any combination of the stated values, inclusive of the stated values.

Epoxy monomers used in the acrylate-based tie layer film formulation are those monomers that are initiated by cationic initiators. The preferred epoxy monomers are epoxy condensation polymers, such as polyglycidyl ethers of alcohols and phenols, and certain polyepoxy monomers and oligomers. The epoxy monomers improve adhesion of the cured acrylate-based tie layer film to the photochromic coating and enhance other properties of the cured acrylate-based tie layer film (AB film), such as improving the adhesion of an abrasion-resistant coating, e.g., a siloxane coating, to the cured acrylate-based tie layer film. Cured acrylate-based tie layer films prepared with epoxy monomers also appear to improve the abrasion resistance of the abrasion-resistant coating (hard coat), when used, that is applied to the photochromic coating and results also in less crazing of the antireflective coating (when used over the hard coat).

Epoxy monomers, e.g., monomers having at least one epoxy group in the molecule can be represented by the following general formula XIV, 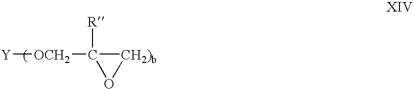
wherein Y is a residue of a b-valent alcoholic hydroxyl compound, a residue of a b-valent phenolic hydroxyl group-containing compound, or a residue of a b-valent carboxylic acid, R″ is a hydrogen atom or a methyl group, and b is an integer of from 1 to 4, typically 1 to 2. These materials include alcoholic hydroxyl group-containing compounds of monohydric dihydric or trihydric alcohols, reaction products between phenolic hydroxyl compounds, such as phenol and hydroquinone, and epichlorohydrin, and reaction products between carboxylic acids, such as benzoic acid and terephthalic acid, and epichlorohydrin.

The epoxy monomer represented by formula XIV can also contain (as part of Y) a radical polymerizable group (other than acrylic) such as a vinyl group or an allyl group. Monomers containing an acrylic polymerizable group and an epoxy group are categorized herein with the acrylate monomer(s) previously described.

Non-limiting examples of epoxy monomer compounds having at least one epoxy group in the molecule and not having a polymerizable group include those of formula XIV wherein b is 1 or 2. When b is 1, Y can be an alkyl group having from 2 to 20 carbon atoms, which can be substituted by a hydroxyl group, a cycloalkyl group having from 6 to 7 carbon atoms, which can be substituted by a hydroxyl group, a phenyl group, which can be substituted by a hydroxyl group, a benzoyl group, which can be substituted by a carboxyl group, or a hydroxyalkyleneoxy group. When b is 2, Y can be an alkylene group containing from 2 to 20 carbon atoms, which can be substituted by a hydroxyl group, a cycloalkylene group, which can be substituted by a hydroxyl group, a phenylene group, which can be substituted by a hydroxyl group, a phthaloyl group, an isophthaloyl group, a terephthaloyl group, a 2,2′-bisphenylene propyl group, and an alkyleneoxy group. The alkyleneoxy group can have from 1 to 20 alkyleneoxy groups, and the alkylene moiety can have from 2 to 4 carbon atoms.

Non-limiting examples of epoxy compounds include ethylene glycol glycidyl ether, propylene glycol glycidyl ether, 1,4-butanediol diglycidyl ether, glycerol polyglycidyl ether, diglycerol polyglycidyl ether, sorbitol polyglycidyl ether, butyl glycidyl ether, phenyl glycidyl ether, polyethylene glycol diglycidyl ether, polypropylene glycol diglycidyl ether, neopentyl glycol diglycidyl ether, 1,6-hexanediol diglycidyl ether, propylene carbonate, bisphenol A or hydrogenated bisphenol A propylene oxide adduct, diglycidyl ester of terephthalic acid, spiroglycol diglycidyl ether, hydroquinone diglycidyl ether and 3,4-epoxycyclohexane carboxylate.

Epoxy condensation polymers that can be used are polyepoxides having a 1,2-epoxy equivalency greater than 1, e.g., up to 3. Non-limiting examples of such epoxies are polyglycidyl ethers of polyhydric phenols and aliphatic (cyclic and alicyclic) alcohols. These polyepoxides can be produced by etherification of the polyhydric phenol or aliphatic alcohol with an epihalohydrin, such as epichlorohydrin, in the presence of an alkali, such as sodium hydroxide. Non-limiting examples of suitable polyphenols are 2,2-bis(4-hydroxyphenyl)propane, e.g., bisphenol A, 1,1-bis(4-hydroxyphenyl)ethane, and 2-methyl-1,1-bis(4-hydroxyphenyl)propane. Non-limiting examples of aliphatic alcohols include ethylene glycol, diethylene glycol, 1,2-propylene glycol, 1,4-butylene glycol, 1,2-cyclohexanediol, 1,4-cyclohexanediol, 1,2-bis(hydroxymethyl)cyclohexane and hydrogenated bisphenol A. These epoxies are available from Resolution Performance Products under the EPON trade name.

Non-limiting examples of polyepoxide monomers and oligomers are described in U.S. Pat. No. 4,102,942 (column 3, lines 1-16). Specific examples of such polyepoxides are 3,4-epoxycyclohexylmethyl, 3,4-epoxycyclohexanecarboxylate and bis(3,4-epoxycyclohexylmethyl)adipate. Aliphatic polyepoxides are available from the Dow Corporation under the CYRACURE trade name.

Monomeric materials that can be used to prepare the curable second transparent polymeric film/layer formulation are commercially available; and, if not commercially available, can be prepared by procedures well known to those skilled in the art. Non-limiting examples of commercial acrylate materials can be found in U.S. Pat. No. 5,910,375, particularly in the disclosure found in column 8, lines 20-55, and in column 10, lines 5-36. Commercially available acrylate materials are available from various manufacturers and include those sold under the tradenames, SARTOMER, EBECRYL, and PHOTOMER.

The transparent second polymeric film/layer formulation can include other additives known to those skilled in the art. These additives can include, but are not limited to, flow and leveling additives, wetting agents, antifoaming agents, UV absorbers, rheology modifiers, surfactants, e.g., fluorosurfactants, stabilizers and antioxidants. Care should be observed, however, in the case of UV absorbers that sufficient UV radiation of the appropriate wavelength is permitted to pass through the second polymeric film/layer to activate the photochromic materials(s) within the photochromic polymeric coating. Such materials are well known to those skilled in the art, and examples of some commercial surfactants and antioxidants/stabilizers can be found in column 10, lines 43-54 of the aforementioned '375 patent. Other examples of such additives include silicones, modified silicones, silicone acrylates, hydrocarbons, and other fluorine-containing compounds.

As disclosed in copending U.S. patent application Ser. No. ______ filed on same date as the present application by W. Blackburn et al and entitled “Photochromic Optical Article”, it is contemplated further that an adhesion-enhancing amount of at least one adhesion promoting material (adhesion promoter) can be incorporated into the curable composition comprising the transparent second polymeric layer. By adhesion-enhancing amount is meant that the compatibility of the second transparent polymeric layer to a superimposed abrasion-resistant coating (as described herein), e.g., an organo silane-containing abrasion resistant coating, is enhanced. Typically, from 0.1 to 20 weight percent of at least one adhesion promoter(s) is incorporated into the coating composition comprising the second transparent polymeric layer prior to applying it onto the photochromic coating. More particularly, from 0.5 to 16, e.g., 0.5 to 10, weight percent, more particularly 0.5 to 8, e.g., 5, weight percent, of at least one adhesion promoter is incorporated into the second transparent polymeric layer. The amount of adhesion promoter incorporated into the second transparent polymeric layer can range between any combination of the aforestated values, inclusive of the recited values.

Among the adhesion promoter materials that can be incorporated into the second transparent polymeric layer to enhance its compatibility with an abrasion-resistant coating, e.g., an abrasion-resistant coating comprising organo-silane material, include, but are not limited to, adhesion promoting organo-silane materials, such as aminoorganosilanes and silane coupling agents, organic titanate coupling agents and organic zirconate coupling agents.

Aminoorganosilanes that can be used are primary, secondary and tertiary aminoorganosilanes, particularly aminoorganosilanes represented by the following general formula XV: 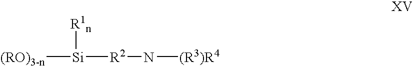
wherein n is an integer of from 0 to 2, usually 0 or 1; each R is independently chosen from C₁-C₈ alkyl, usually C₁-C₄ alkyl, such as methyl, ethyl, propyl and butyl, a C₁-C₄ alkoxy C₁-C₈ alkyl, typically C₁-C₃ alkoxy C₁-C₃ alkyl, such as methoxymethyl, methoxyethyl, ethoxymethyl, etc., or C₆-C₁₀ aryl, e.g., C₆-C₈ aryl; R¹ is hydrogen or a C₁-C₈ alkyl, usually C₁-C₃ alkyl, or C₆-C₁₀ aryl, e.g., C₆-C₈ aryl; R² is a divalent C₁-C₁₀ alkylene, C₂-C₁₀ alkenylene or phenylene, usually a C₂-C₅ alkylene, such as ethylene, trimethylene, etc., or C₂-C₅ alkenylene, such as vinylene, 1-propenylene, butenylene, 2-pentenylene, etc.; each R³ and R⁴ are independently chosen from hydrogen, C₁-C₈ alkyl, usually C₁-C₃ alkyl, C₁-C₈ hydroxyalkyl, usually C₂-C₃ hydroxyalkyl, C₁-C₈ aminoalkyl, usually C₂-C₃ aminoalkyl, C₄-C₇ cycloalkyl, e.g., C₅-C₆ cycloalkyl, C₆-C₁₀ aryl, e.g., C₆-C₈ aryl, (meth)acrylyloxy C₁-C₄ alkyl (the alkyl group being optionally substituted with a functional group such as hydroxy), e.g., (meth)acrylyloxy-2-hydroxypropyl, or R³ and R⁴ combine to form a cycloalkyl group of from 4 to 7 carbon atoms, e.g., 5 to 6 carbon atoms, or a C₄-C₇ heterocyclic group wherein the hetero atom(s) are oxygen and/or nitrogen, e.g., morpholino and piperazino, or are a group represented by the general formula XVA 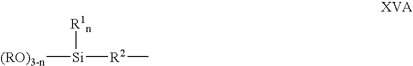
wherein R, R¹, R² and n are as defined with respect to general formula XV. Also included in the compounds of formula XV are the partial and total hydrolysates of compounds represented by that formula.

Non-limiting examples of aminosilanes that can be used include aminopropyl trimethoxysilane, aminopropyl triethoxysilane, aminoethyl trimethoxysilane, aminoethyl triethoxysilane, methylaminopropyl trimethoxysilane, aminobutylmethyl dimethoxysilane, aminopropyldimethyl methoxysilane, aminopropylmethyl dimethoxysilane, aminopropyldimethyl ethoxysilane, aminobutylmethyl dimethoxysilane, bis-(gamma-trimethoxysilylpropyl) amine, N-(3-methacryloxy-2-hydroxypropyl)-3-aminopropyl triethoxysilane, N-(3acryloxy-2-hydroxypropyl)-3-aminopropyl triethoxysilane, (N,N-dimethylaminopropyl) trimethoxysilane, (N,N-diethyl-3-aminopropyl) trimethoxysilane, diethylaminomethyl triethoxysilane, bis(2-hydroxyethyl)-3-aminopropyl triethoxysilane, γ-aminopropyl trimethoxysilane, N-(2′-aminoethyl)-3-aminopropyl trimethoxysilane, N-(2′-aminoethyl)-3-aminopropyl triethoxysilane, N-butyl-3-aminopropyl triethoxysilane, N-octyl-3-aminopropyl trimethoxysilane, N-cyclohexyl-3-aminopropyl triethoxysilane, N-(3′-triethoxysilylpropyl)-piperazine, bis-(3-triethoxysilylpropyl)amine, tris-(3-trimethoxysilylpropyl)amine, N,N-dimethyl-3-aminopropyl triethoxysilane, N-methyl-N-butyl-3-aminopropyl triethoxysilane, N-(3′-aminopropyl)-3-aminopropyl triethoxysilane, N-(3′-triethoxysilylpropyl) morpholine, N-phenyl-gamma-aminopropyl trimethoxysilane, and N-phenyl-gamma-amino-2-methylpropyl trimethoxysilane.

Silane coupling agents can be represented by the following general formula XVI:
(R⁵)ₐ(R⁶)_{b}Si[(OR)₃]_{c} XVI
wherein each R⁵ is an organofunctional group independently chosen from epoxy, glycidoxy, amino, vinyl, styryl, (meth)acryloxy, mercapto, haloalkyl, e.g., chloroalkyl, ureido, or a hydrocarbon radical having not more than 10 carbon atoms substituted with said organofunctional group; each R is a hydrocarbon radical of not more than 20 carbon atoms, that is independently chosen from aliphatic radicals, aromatic radicals or mixtures of such hydrocarbon radicals, e.g., C₁-C₂₀ alkyl, more particularly, C₁-C₁₀ alkyl, e.g., C₁-C₆ alkyl, or phenyl; each R is independently chosen from C₁-C₈ alkyl, usually C₁-C₄ alkyl, such as methyl, ethyl, propyl and butyl, a C₁-C₄ alkoxy C₁-C₈ alkyl, typically C₁-C₃ alkoxy C₁-C₃ alkyl, such as methoxymethyl, methoxyethyl, ethoxymethyl, etc., C₆-C₁₀ aryl, e.g., C₆-C₈ aryl or acetoxy;, a is the integer 1 or 2, usually 1, b is the integer 0, 1 or 2, e.g., 0, and c is the integer 1, 2, or 3, e.g., 2 or 3, provided that the sum of a+b+c equals 4.

Non-limiting examples of silane coupling agents include: vinyl triacetoxysilane, vinyl trimethoxysilane, vinyl tri(2-methoxyethoxy)silane, vinyl triphenoxysilane, vinyl triisopropoxysilane, vinyl tri-t-butoxysilane, divinyl diethoxysilane, gamma glycidoxypropyl trimethoxysilane, beta-(3,4-epoxycyclohexyl)ethyl trimethoxysilane, allyl triethoxysilane, allyl trimethoxysilane, (3-acryloxypropyl) dimethylmethoxysilane, (3-acryloxypropyl) methyldimethoxysilane, (3-acryloxypropyl) trimethoxysilane, (3-methacryloxypropyl) trimethoxysilane, (methacryloxymethyl) dimethyl ethoxysilane, methacryloxymethyl triethoxysilane, methacryloxymethyl trimethoxysilane, methacryloxypropyl dimethyl ethoxysilane, methacryloxypropyl trimethoxysilane, styrylethyl trimethoxysilane, mercaptomethyl methyldiethoxysilane, 3-mercaptopropyl methyldimethoxysilane, 3-mercaptopropyl triethoxysilane, 3-mercaptopropyl trimethoxysilane, 3,4-epoxy cyclohexylethyl trimethoxysilane, dimethyl diethoxysilane, chloropropyl triethoxysilane, 3-(trimethoxysilyl)propyl methacrylate, ureidopropyl triethoxysilane, mixtures of such silane materials, and at least partial hydrolysates of such silanes.

Non-limiting examples of organic titanate coupling agents include: tetra (2,2-diallyloxymethyl)butyl titanate, di(ditridecyl)phosphito titanate (commercially available as KR 55 from Kenrich Petrochemicals, Inc.); neopentyl(diallyl)oxy trineodecanoyl titanate; neopentyl (diallyl)oxy tri(dodecyl)benzene-sulfonyl titanate; neopentyl (diallyl)oxy tri(dioctyl)phosphato titanate; neopentyl (diallyl)oxy tri(dioctyl) pyro-phosphato titanate; neopentyl (diallyl)oxy tri (N-ethylenediamino)ethyl titanate; neopentyl (diallyl)oxy tri(m-amino) phenyl titanate; neopentyl (diallyl)oxy trihydroxy caproyl titanate; isopropyl dimethyacrylisostearoyl titanate; tetraisopropyl (dioctyl) phosphito titanate; mixtures of such titanates, and at least partial hydrolysates thereof.

Non-limiting examples of organic zirconate coupling agents include tetra (2,2-diallyloxymethyl)butyl di(ditridecyl)phosphito zirconate (commercially available as KZ 55 from Kenrich Petrochemicals); neopentyl(diallyloxy) trineodecanoyl zirconate; neopentyl(diallyl)oxy tri(dodecyl)benzene sulfonyl zirconate; neopentyl(diallyloxy) tri(dioctyl)phosphato zirconate; neopentyl (diallyloxy) tri(dioctyl)pyro-phosphato zirconate; neopentyl(diallyloxy) tri(N-ethylenediamino)ethyl zirconate; neopentyl (diallyloxy), tri(m-amino)phenyl zirconate; neopentyl (diallyloxy) trimethacryl zirconate; neopentyl (diallyloxy) triacryl zirconate; dineopentyl(diallyloxy) di(p-amino) benzoyl zirconate; dineopentyl (allyl)oxy di(3-mercapto) propionic zirconate; mixtures of such zirconates, and at least partial hydrolysates thereof.

As used in this description and claims, the term “at least partial hydrolysates” is intended to mean and include compounds that are hydrolyzed partially or hydrolyzed completely.

The curable second transparent polymeric film formulation is prepared by mixing the components of the formulation at room temperature, although mild heating can be used to facilitate mixing and blending. The formulation can then be applied to the photochromic coating by the same procedures that have been described for applying the photochromic coating to the plastic substrate, e.g., spin coating and dip coating.

Prior to applying the curable second transparent polymeric composition to the surface of the photochromic coating, that surface is often cleaned and treated to enhance adhesion of the second transparent polymeric film to the photochromic coating. Non-limiting examples of such treatments include activated gas treatment, such as treatment with a low temperature plasma or corona discharge. A particularly desirable surface treatment is a low temperature plasma treatment. This method allows treatment of the surface to enhance adhesion of a superimposed film or coating, and is a clean and efficient way to alter the physical surface, e.g., by roughening and/or chemically altering the surface without affecting the rest of the article. Inert gases, such as argon, and reactive gases, such as oxygen, have been used as the plasma gas. Inert gases will roughen the surface, while reactive gases such as oxygen will both roughen and chemically alter slightly the surface exposed to the plasma, e.g., by producing hydroxyl or carboxyl units on the surface. Oxygen is used desirably as the plasma gas because it is believed that it provides a slight, but effective, physical roughening of the surface along with a slight, but effective, chemical modification of the surface. Naturally, the extent of the surface roughening and/or chemical modification will be a function of the plasma gas and the operating conditions of the plasma unit (including the length of time of the treatment).

It is reported that a conventional plasma treatment alters the top 20 to 200 angstroms of the surface (a few molecular layers.) The operating conditions of the plasma unit are a function of the design and size, e.g., volume, of the plasma chamber, power and construction of the plasma unit. The frequency at which the plasma operates can vary, e.g., from a low frequency such as 40 kHz to microwave frequencies such as 2.45 GHz. Similarly, the power at which the plasma unit operates can vary, e.g., from 50 to 1000 Watts, e.g., 50 to 750, such as 50 to 150 Watts. The pressure at which the plasma unit operates can also vary; however, it has been observed that low pressures are generally less destructive physically of the treated surface, which is desired. Low pressures, e.g., from 20 to 65 or 70 Pa are believed to be useful. The time that the surface is exposed to the plasma can also vary and will be a function of the type of surface being treated, e.g., the type of polymer used for the photochromic polymeric coating. However, care should be taken that the surface is not treated for too long since lengthy periods of treatment can be counterproductive. One skilled in the art can readily determine the minimum time required to provide a plasma treated surface that enhances adhesion of the chosen film to the photochromic coating. For ophthalmic articles, such as lenses, the length of the plasma treatment will generally vary from 1 to 10 minutes, e.g., 1 to 5 minutes. One contemplated plasma treatment involves use of an oxygen plasma generated by a Plasmatech machine operating at a power level of 100 Watts for from 1 to 10, e.g., 1 to 5 minutes, while introducing 100 ml/minute of oxygen into the vacuum chamber of the Plasmatech machine.

The curable second transparent polymeric film is applied in a manner to obtain a substantially homogeneous cured film, the thickness of which can vary. In one contemplated embodiment, the thickness is less than 200 microns, usually less than 100 microns, e.g., not more than 50 microns. In another contemplated embodiment, the film can range in thickness from 2 to 20 microns, e.g., 2 to 15 microns, more typically from 8 to 12 microns. The film thickness can range between any combinations of these values, inclusive of the recited values. It is contemplated that more than one polymeric film can be used as the tie layer, and that such multiple films can be of different compositions and hardness values. The term “film” is generally considered by those skilled in the coating art to be a layer with a thickness of not more than 20 mils (500 microns); however, as used in this disclosure and claims, the term film when used in relation to the second transparent polymeric film is defined as having a thickness, as herein described.

The applied film is then cured by any appropriate method, e.g., thermally and/or exposure to UV radiation. Any appropriate type of UV lamp, e.g., mercury vapor or pulsed xenon, can be used. The absorbance spectra of the photoinitiator(s) should be matched with the spectral output of the UV lamp (bulb), e.g., an H bulb, D bulb, Q bulb or V bulb, for the highest curing efficiency. The cure process is generally more efficient when oxygen, e.g., air, is excluded from the cure process. This can be accomplished by using a nitrogen blanket over the applied film during the cure process.

Following the UV cure, a thermal post cure can be used to cure completely the AB film. Heating in an oven at 212° F. (100° C.) for from 0.5 to 3 hours is usually adequate to thoroughly cure the AB film. The previous discussion respecting radiation curing of the photochromic coating is also applicable here in connection with the cure of the second transparent polymeric film.

In a further contemplated embodiment, an abrasion-resistant coating is superposed, e.g., superimposed, on the photochromic polymeric coating or the second transparent polymeric layer/film. In the later embodiment, the post thermal cure of the second polymeric layer/film can be postponed until after application of the abrasion-resistant coating if there is no significant physical handling of the product until after application of the abrasion-resistant coating. If such extensive handling is required, it is suggested that the thermal post cure be performed prior to application of the abrasion-resistant coating.

The scratch resistance of the second transparent polymeric layer/film can be measured by the conventional steel wool scratch test. This test measures the average haze gain of a surface subjected to abrasion by very fine steel wool. In accordance with a preferred embodiment of the present invention, the average haze gain should be less than 20, desirably less than 15, more desirably less than 10, and still more desirably less than 8. An Eberbach Steel Wool Abrasion Tester can be used to determine surface scratch resistance. A Bayer Abrasion Tester can also be used to determine surface abrasion resistance.

Desirably, the second transparent polymeric layer/film should also adhere firmly to the photochromic coating applied to the transparent, e.g., plastic, substrate. Adhesion can be determined by the conventional art recognized crosshatch tape peel adhesion test, and by a boiling water crosshatch tape peel adhesion test, which is a more stringent test. The former is often referred to as the primary (1°) test or dry test; while the later is often referred to as the secondary (2°) or wet test. In the primary test, a cutting tool composed of eleven blades spaced approximately 1 mm apart (tip to tip) and 0.65 mm thick is used to make a first long cut on the sample followed by second and third cuts, which are made at 90 degrees to and across the first cut. The second and third cuts are separated from each other to provide separate crosshatch zones. A piece of Scotch 3M masking tape one inch (2.54 cm) wide and 2 to 2½ inches long (5 to 6.3 cm) is applied in the direction of the first cut and pressed down to smooth out any bubbles. The tape is then peeled off the surface with a sharp, rapid, even and continuous movement. The procedure is repeated with a fresh piece of tape. A small piece of tape (1½ inches, 3.8 cm) is applied to each of the crosshatch zones produced by the second and third cuts in a direction 90 degrees to the direction of the first tape, and these pieces of tape also peeled off the surface with a sharp, rapid, even and continuous movement. If 30 percent or less of the squares of the grid produced by the cutting tool are found to have debonded from the substrate (photochromic coating), e.g., at least 70 percent of the grids remain intact, the coating is deemed to pass the adhesion test. More particularly, it is desirable that no more than 20, particularly no more than 10, squares, still more particularly, no more than 5 squares, e.g., 1 square, out of a 100 squares of the grid de-bond from the substrate. In accordance with an embodiment of the present invention, the second transparent polymeric film should pass the crosshatch tape peel adhesion test to be considered to have adhered to the photochromic coating. Stated differently, if the second transparent polymeric layer/film passes the crosshatch tape peel test, it is referred to herein as being coherently appended (or cohesively appended) or attached to the layer, e.g., the photochromic coating, to which it is appended.

A further more severe adhesion test is the secondary or wet adhesion test, which optionally can be performed to assess adhesion. This further test, e.g., the boiling water cross-hatch adhesion test, involves placing the test sample, e.g., lens, which has been scored with cross hatches, as described above, in boiling deionized water for 30 minutes. After the test sample has cooled to room temperature, the crosshatch tape peel adhesion test, as described above, is performed again. The same pass/fail requirements that were described for the crosshatch adhesion test are used for this boiling water modification of the test.

It is also desirable that the second transparent polymeric layer/film be resistant to removal by aqueous inorganic caustic solutions, e.g., relatively dilute alkali metal hydroxide solutions, such as solutions of sodium hydroxide or potassium hydroxide. The film is considered to be resistant to removal by such solutions if the thickness of the film is reduced not more than 0.5 micron after exposure to 12.5% aqueous potassium hydroxide at 140° F. (60° C.) for four minutes. Desirably, the film thickness is not reduced more than 0.5 microns after two exposures, more desirably after three exposures, to the aqueous potassium hydroxide solution.

It is further desirable that the second transparent polymeric layer/film be compatible with organo silane-containing abrasion-resistant coatings used to protect plastic surfaces from abrasions, scratches, etc, and which can be appended to the second transparent polymeric layer. Organo silane abrasion-resistant coatings, often referred to as hard coats or silicone-based hard coatings, are well known in the art, and are commercially available from various manufacturers, such as SDC Coatings, Inc. and PPG Industries, Inc. Reference is made to column 5, lines 1-45 of U.S. Pat. No. 4,756,973, and to column 1, lines 58 through column 2, line 8, and column 3, line 52 through column 5, line 50 of U.S. Pat. No. 5,462,806, which disclosures describe organo silane hard coatings. Reference is also made to U.S. Pat. Nos. 4,731,264, 5,134,191, 5,231,156 and International Patent Publication WO 94/20581 for disclosures of organo silane hard coatings.

While a described desirable physical feature of the second transparent polymeric layer/film is that it be compatible with organo silane hard coatings, other coatings that provide abrasion and scratch resistance, such as polyfunctional acrylic hard coatings, melamine-based hard coatings, urethane-based hard coatings, alkyd-based coatings, silica sol-based hard coatings or other organic or inorganic/organic hybrid hard coatings can be used as the abrasion-resistant coating.

One skilled in the art can readily determine if the second transparent polymeric layer/film is compatible with organo silane hard coatings by applying an organo silane hard coat to the second transparent polymer layer and determining the compatibility of the second polymeric layer/film to that hard coat by means of the cross-hatch tape peel adhesion test, which is performed on the hard coat. Another method of determining compatibility of the second transparent polymeric layer to the hard coat is the absence of crazing in the hard coat after it has been applied to the second polymeric layer and cured. By crazing is meant the presence of fractures in the hard coat. Such fractures are sometimes readily apparent by observation; however, the fractures can be very fine and observable by magnification under bright light. The light source consists of a high intensity white arc light of a 75 watt Xenon bulb, with the light being projected vertically down through the hard coat.

By use of the term “compatible with an organo silane abrasion resistant coating (hard coat)” is meant that the specified layer, coating or film is capable of having an organo silane hard coat deposited on its surface and that the organo silane hard coat adheres to the film under ordinary handling/wear conditions. Naturally, the organo silane hard coat can be removed by treatment with concentrated aqueous caustic, or severe mechanical abrasion. Further, the term abrasion-resistant organo silane-containing coating (or other such similar meaning terms) is meant that the abrasion-resistant coating is prepared from a composition comprising at least one organo silane.

It is contemplated that, if required, a primer coating is applied to the transparent second polymeric layer before applying the abrasion-resistant coating on top of it. Such primer coatings are known in the art. Selection of an appropriate primer coating will depend on the particular second polymeric layer and abrasion-resistant coating used, e.g., the primer coating must be chemically and physically compatible (non-reactive) with the surfaces that it abuts. The primer coating can be one or several monomolecular layers thick, and can range from 0.1 to 10 microns, e.g., from 0.1 to 2 or 3 microns, in thickness. Such primer coatings are discussed herein in relation to the photochromic coating, and that discussion is applicable here also.

In one embodiment, the hard coat can be prepared from a composition comprising from 35 to 95 weight percent, as calculated solids, of at least one organo silane monomer represented by the following empirical formula XVII:
R¹SiW₃ XVII
wherein R¹ is glycidoxy(C₁-C₂₀)alkyl, desirably glycidoxy(C₁-C₁₀)alkyl, and more desirably, glycidoxy (C₁-C₄)alkyl; W is hydrogen, halogen, hydroxy, C₁-C₅ alkoxy, C₁-C₅ alkoxy(C₁-C₅)alkoxy, C₁-C₄ acyloxy, phenoxy, C₁-C₃ alkylphenoxy, or C₁ -C₃ alkoxyphenoxy, said halogen being bromo, chloro or fluoro. Desirably, W is hydrogen, halogen, hydroxy, C₁-C₃ alkoxy, C₁-C₃ alkoxy(C₁-C₃)alkoxy, C₁-C₂ acyloxy,.phenoxy, C₁-C₂ alkylphenoxy, or C₁-C₂ alkoxyphenoxy, and the halogen is chloro or fluoro. More desirably, W is hydroxy, C₁-C₃ alkoxy, C₁-C₃ alkoxy(C₁-C₃)alkoxy, C₁-C₂ acyloxy, phenoxy, C₁-C₂ alkylphenoxy, or C₁-C₂ alkoxyphenoxy.

The weight percent, as calculated solids, of the silane monomers represented by empirical formula XVII in the hard coat composition is desirably from 40 to 90, more desirably from 45 to 85, and most desirably from 50 to 70 weight percent calculated solids. The weight percent calculated solids are determined as the percent of the silanol that theoretically forms during the hydrolysis of the orthosilicate.

Non-limiting examples of silane monomers represented by general formula XVII include glycidoxymethyltriethoxysilane, glycidoxymethyltrimethoxysilane, alpha-glycidoxyethyltrimethoxysilane, alpha-glycidoxyethyltriethoxysilane, alpha-glycidoxypropyltrimethoxysilane, alpha-glycidoxypropyltriethoxysilane, alpha-glycidoxypropyltrimethoxysilane, alpha-glycidoxypropyltriethoxysilane, beta-glycidoxyethyltrimethoxysilane, beta-glycidoxyethyltriethoxysilane, beta-glycidoxypropyltrimethoxysilane, beta-glycidoxypropyltriethoxysilane, beta-glycidoxybutyltrimethoxysilane, beta-glycidoxybutyltriethoxysilane, gamma-glycidoxypropyltrimethoxysilane, gamma-glycidoxypropyltriethoxysilane, gamma-glycidoxypropyltripropoxysilane, gamma-glycidoxypropyltributoxysilane, gamma-glycidoxypropyltrimethoxysilane, gamma-glycidoxypropyltriphenoxysilane, gamma-glycidoxybutyltrimethoxysilane, gamma-glycidoxybutyltriethoxysilane, delta-glycidoxybutyltrimethoxysilane, delta-glycidoxybutyltriethoxysilane, hydrolyzates of such silane monomers, and mixtures of such silane monomers and hydrolyzates thereof.

The hard coat composition of the foregoing described embodiments can further include from 5 to 65 weight percent, as calculated solids, of: (a) silane monomers represented by empirical formula XVIII, (b) metal alkoxides represented by empirical formula XIX, or (c) a mixture thereof in a weight ratio of (a):(b) of from 1:100 to 100:1. Desirably, the hard coat composition includes from 10 to 60 weight percent calculated solids, more desirably from 15 to 55, and most desirably from 30 to 50 weight percent calculated solids of the aforementioned materials (a), (b) or (c).

The hard coat composition can include at least one silane monomer represented by the following empirical formula XVIII:
R²_{b}(R³)_{c}SiZ_{4-(b+C)} XVIII
wherein R² can be C₁-C₂₀ alkyl, C₁-C₂₀ haloalkyl, C₂-C₂₀ alkenyl, C₂-C₂₀ haloalkenyl, phenyl, phenyl(C₁-C₂₀)alkyl, C₁-C₂₀ alkylphenyl, phenyl(C₂-C₂₀)alkenyl, C₂-C₂₀ alkenylphenyl, morpholino, amino(C₁-C₂₀)alkyl, amino(C₂-C₂₀)alkenyl, mercapto(C₁-C₂₀)alkyl, mercapto(C₂-C₂₀)alkenyl, cyano(C₁-C₂₀)alkyl, cyano(C₂-C₂₀)alkenyl, acryloxy, methacryloxy, or halogen. The halo or halogen can be bromo, chloro, or fluoro. Desirably, R² is a C₁-C₁₀ alkyl, C₁-C₁₀ haloalkyl, C₂-C₁₀ alkenyl, phenyl, phenyl(C₁-C₁₀()alkyl, C₁-C₁₀ alkylphenyl, morpholino, amino(C₁-C₁₀) alkyl, amino(C₂-C₁₀) alkenyl, mercapto(C₁-C₁₀)alkyl, mercapto(C₂-C₁₀) alkenyl, cyano(C₁-C₁₀) alkyl, cyano(C₂-C₁₀)alkenyl, or halogen and the halo or halogen is chloro or fluoro.

In formula XVIII, R³ can be C₁-C₂₀ alkylene, C₂-C₂₀ alkenylene, phenylene, C₁-C₂₀ alkylenephenylene, amino(C₁-C₂₀)alkylene, amino(C₂-C₂₀)alkenylene; Z can be hydrogen, halogen, hydroxy, C₁-C₅ alkoxy, C₁-C₅ alkoxy(C₁-C₅)alkoxy, C₁-C₄ acyloxy, phenoxy, C₁-C₃ alkylphenoxy, or C₁-C₃ alkoxyphenoxy, said halo or halogen being bromo, chloro or fluoro; b and c are each an integer of from 0 to 2; and the sum of b and c is an integer of from 0 to 3. Desirably, R³ is C₁-C₁₀ alkylene, C₂-C₁₀ alkenylene, phenylene, C₁-C₁₀ alkylenephenylene, amino(C₁-C₁₀)alkylene, amino(C₂-C₁₀)alkenylene, Z is hydrogen, halogen, hydroxy, C₁-C₃ alkoxy, C₁-C₃ alkoxy(C₁-C₃)alkoxy, C₁-C₂ acyloxy, phenoxy, C₁-C₂ alkylphenoxy, or C₁-C₂ alkoxyphenoxy, and the halo or halogen is chloro or fluoro.

Non-limiting examples of silane monomers represented by general formula XVIII include methyltrimethoxysilane, methyl-triethoxysilane, methyltrimethoxyethoxysilane, methyltri-acetoxysilane, methyltripropoxysilane, methyltributoxysilane, ethyltrimethoxysilane, ethyltriethoxysilane, and gamma-methacryloxypropyl

trimethoxysilane, gamma-aminopropyltrimethoxysilane, gamma-aminopropyltriethoxysilane, gamma-mercaptopropyltrimethoxysilane, chloromethyltrimethoxysilane, chloromethyltriethoxysilane, dimethyldiethoxysilane, gamma-chloropropylmethyldimethoxysilane, gamma-chloropropyl-methyldiethoxysilane, tetramethylorthosilicate, tetraethylorthosilicate, hydrolyzates of such silane monomers, and mixtures of such silane monomers and hydrolyzates thereof.

The hard coat composition can further include at least one compound represented by empirical formula XIX:
M(T)_{q} XIX
wherein M is a metal chosen from aluminum, antimony, tantalum, titanium or zirconium; T is C₁-C₁₀ alkoxy and q is an integer equivalent to the valence of M. Desirably, M is chosen from aluminum, titanium or zirconium and T is C₁-C₅ alkoxy, e.g., propoxy.

The hard coat composition can also include from 0 to 20 weight percent, based on the total weight of the composition, of a metal oxide chosen from silicon dioxide (silica), aluminum oxide (alumina), antimony oxide, tin oxide, titanium oxide, zirconium oxide or mixtures of such metal oxides. The metal oxide can be in the form of a sol. As used in the present specification, the term sol means and includes a colloidal dispersion of finely divided solid inorganic metal oxide particles in an aqueous or an organic liquid. The average size of such particles can range from 1 to 200 nanometers, typically from 2 to 100 nanometers, and more typically, from 5 to 50 nanometers.

Such metal oxide sols can be prepared by hydrolyzing a metal salt precursor for a time sufficient to form the desired particle size or such sols can be purchased commercially. Examples of commercially available metal oxide sols that can be used in the hard coat composition include NALCO® colloidal sols (available from NALCO Chemical Co.), REMASOL® colloidal sols (available from Remet Corp.) and LUDOX® colloidal sols (available from E. I. du Pont de Nemours Co., Inc.). Stable acidic and alkaline metal oxide sols are commercially available as aqueous dispersions. Desirably, the metal oxide is silica or alumina supplied in the form of an acid stabilized colloidal silica, acid stabilized colloidal alumina, e.g., NALCO® 8676, or an acid stabilized alumina coated silica sol, e.g., NALCO® 1056. Metal oxide sols can also be obtained as dispersions in organic liquids, e.g., ethanol, isopropyl alcohol, ethylene glycol and 2 propoxyethanol.

The hard coat composition also contains a catalytic amount of a water-soluble acid catalyst. A catalytic amount is that amount which is sufficient to cause polycondensation of the silane monomer(s). Typically, the catalytic amount of acid catalyst will range from 0.01 to 10 weight percent, based on the total weight of the hard coat composition. The water-soluble acid catalyst can be an organic carboxylic acid or an inorganic acid. Non-limiting examples of suitable catalysts include acetic acid, formic acid, glutaric acid, maleic acid, nitric acid, sulfuric acid and hydrochloric acid.

Organic solvents present in the hard coat composition can be added or formed in situ by the hydrolysis of the silane monomer(s). Useful organic solvents are those that will dissolve or disperse the solid components of the coating composition. The minimum amount of solvent present in the coating composition is a solvating amount, e.g., an amount that is sufficient to solubilize or disperse the solid components in the coating composition. For example, the amount of solvent present can range from 20 to 90 weight percent based on the total weight of the coating composition and depends, in part, on the amount of silane monomer present in the coating composition. Examples of solvents include, but are not limited to, the following: benzene, toluene, methyl ethyl ketone, methyl isobutyl ketone, acetone, ethanol, tetrahydrofurfuryl alcohol, propyl alcohol, propylene carbonate, N-methylpyrrolidinone, N-vinylpyrrolidinone, N-acetylpyrrolidinone, N-hydroxymethylpyrrolidinone, N-butyl-pyrrolidinone, N-ethylpyrrolid inone, N-(N-octyl)-pyrrolidinone, N-(n-dodecyl)pyrrolidinone, 2-methoxyethyl ether, xylene, cyclohexane, 3-methylcyclohexanone, ethyl acetate, butyl acetate, tetrahydrofuran, methanol, amyl propionate, methyl propionate, diethylene glycol monobutyl ether, dimethyl sulfoxide, dimethyl formamide, ethylene glycol, mono- and dialkyl ethers of ethylene glycol and their derivatives, which are sold under the trade name CELLOSOLVE industrial solvents, propylene glycol methyl ether and propylene glycol methyl ether acetate, which are sold under the trade name BOWANOL® PM and PMA solvents, respectively, and mixtures of such solvents.

A leveling amount of nonionic surfactant(s) can be present as a component in the hard coat composition. A leveling amount is that amount which is sufficient to allow the coating to spread evenly or to level the hard coat composition on the surface of the polymer film/layer to which it is applied. Desirably, the nonionic surfactant is a liquid at the conditions of use and is used in amounts from about 0.05 to about 1.0 weight percent based on the amount of the silane monomer(s). Suitable nonionic surfactants are described in the Kirk Othmer Encyclopedia of Chemical Technology, 3rd Edition, Volume 22, pages 360 to 377, the disclosure of which is incorporated herein by reference. Other potential nonionic surfactants include the surfactants described in U.S. Pat. No. 5,580,819, column 7, line 32 to column 8, line 46, which disclosure is incorporated herein by reference.

Non-limiting examples of nonionic surfactants that can be used in the hard coat composition include ethoxylated alkyl phenols, such as the IGEPAL® DM surfactants or octyl-phenoxypolyethoxyethanol, which is sold as TRITON® X-100, an acetylenic diol such as 2,4,7,9-tetramethyl-5-decyne-4,7-diol, which is sold as SURFYNOL® 104, ethoxylated acetylenic diols, such as the SURFYNOL® 400 surfactant series, fluoro-surfactants, such as the FLUORAD® fluorochemical surfactant series, and capped nonionics, such as the benzyl capped octyl phenol ethoxylates, which is sold as TRITON® CF87, the propylene oxide capped alkyl ethoxylates, which are available as the PLURAFAC® RA series of surfactants, octylphenoxyhexadecylethoxy benzyl ether, polyether modified dimethylpolysiloxane copolymer in solvent, which is sold as BYK®-306 additive by Byk Chemie and mixtures of such recited surfactants.

Water is also present in the hard coat composition in an amount sufficient to form hydrolysates of the silane monomer(s). The water present in the optional metal oxide sol can supply the amount of water necessary. If not, additional water can be added to the coating composition to provide the required additional amount necessary to hydrolyze the silane monomer(s).

The abrasion-resistant coating (hard coat) can be applied to the second transparent polymeric layer/film using the same application techniques described with respect to the photochromic coating, e.g., spin coating. The abrasion resistant film can be applied at a thickness of from 0.5 to 10 microns. Prior to applying the hard coating, e.g., the organo silane hard coat, to the second transparent polymeric layer/film, the film can be treated to enhance its receptivity of and adhesion of the hard coat. Such treatments, e.g., plasma treatments, as are described above with respect to pretreatment of the photochromic coating can be used.

In a further embodiment of the present invention, additional coatings, such as antireflective coatings, can be applied to the hard coat layer. Examples of antireflective coatings are described in U.S. Pat. No. 6,175,450 and International Patent Publication WO 00/33111.

The present invention is more particularly described in the following examples, which are intended as illustrative only, since numerous modifications and variations therein will be apparent to those skilled in the art. In the examples, percentages are reported as weight percent, unless otherwise specified. Materials, such as monomers, catalysts, initiators, etc.), which are identified in one example by a lower case letter in parenthesis, are similarly identified in subsequent examples.

In the following examples, residual bleach color (b*) values are obtained by use of a Hunter Spectrophotometer and are expressed in Table 4 based on the CIELAB system. See column 7, lines 14-39 of U.S. Pat. No. 5,753,146 and pages 47-52 of Principles of Color Technology, by F. W. Billmeyer, Jr., and Max Saltzman, Second Edition, John Wiley and Sons, New York (1981) for a description of the CIELAB system. In this system, a* and b* describe color, with a positive a* being red, a negative a* being green, a positive b* being yellow and a negative b* being blue. Two dimensional plotting of a* and b* values while a photochromic article activates and fades (cycling) gives a graphic representation of color consistency. Visually, a tight circle will indicate a limited shift in hue while cycling, while a loose circle will attest to major color changes taking place during cycling.

### EXAMPLE 1

In the following example, piano PDQ coated polycarbonate lenses obtained from Gentex Optics were used. The test lenses were treated with an oxygen plasma for 1 minute using a Plasmatech machine at a power setting of 100 Watts while introducing oxygen at a rate of 100 ml/min into the vacuum chamber of the Plasmatech machine.

A photochromic master batch was prepared by mixing 27.2 grams of N-methyl pyrrolidinone and 5.14 grams (total) of 4 different naphthopyran photochromic compounds on a stir plate at 60° C. until the photochromic compounds were dissolved. The photochromic compounds were chosen and used in a ratio that yielded a gray color when the blend was exposed to ultraviolet light.

A photochromic polyurethane coating composition was applied to the plasma treated lenses by spin coating and then thermally cured at 140° C. for 1.5 hours in a convection oven. The components and amounts of the polyurethane composition are tabulated in Table 1. The components of the polyurethane composition were mixed for 60 minutes on a stir plate at room temperature before being applied to the lenses. The photochromic polyurethane coating was approximately 20 microns thick.

TABLE 1
Formulation

| Component/ | Amount, Grams |
|---|---|
| Desmodur PL 3175A (a) | 1.3 |
| Vestanat B 1358A (b) | 3.8 |
| PC 1122 (c) | 4.0 |
| HCS 6234 polyol (d) | 0.9 |
| Dibutyltin dilaurate | 0.08 |
| Photochromic Master batch (e) | 3.8 |

(a) Methyl ethyl ketoxime blocked hexamethylene diisocyanate (Bayer)
(b) Methyl ethyl ketoxime blocked isophorone diisocyanate trimer (CreaNova, Inc.)
(c) Polyhexane carbonate diol (Stahl)
(d) Polyacrylate polyol (Composition D in Example 1 of U.S. Pat. No. 6,187,444 B1)
(e) A mixture in NMP of naphthopyran photochromic materials chosen to produce a gray tint when exposed to UV light.

The test lenses were tested for residual bleach color on a Hunter Spectrophotometer and fade rate on an optical bench. Photochromic migration is evidenced by an increase in the residual bleach color (b*), and an increase in the fade rate. Results are tabulated in Table 4.

### EXAMPLE 2

The procedure of Example 1 was repeated except that an acrylate-based film was appended to the photochromic polyurethane coating. Prior to applying the acrylate based film, the photochromic polyurethane coating was treated with an oxygen plasma for 1 minute using a Plasmatech machine at a power setting of 100 Watts while introducing oxygen at a rate of 100 ml/minute into the vacuum chamber of the Plasmatech machine. The acrylate-based film was prepared from the components and their amounts listed in Table 2 and applied to the test lenses by spin coating. The acrylate-based film was cured in a nitrogen atmosphere with UV light from a D bulb and then post cured for 3 hours at 212° F. (100° C.) in a convection oven. The acrylate-based film was approximately 10 microns thick.

TABLE 2
Formulation

| Component/ | Weight Percent |
|---|---|
| HEMA (f) | 31.1 |
| SR-247 (g) | 30.3 |
| TMPTMA (h) | 10.8 |
| BAPO (i) | 0.2 |
| Lucirin TPO (j) | 0.2 |
| Desmodur PL 340 (k) | 18.1 |
| Dibutyl Tin dilaurate | 0.2 |
| A-1100 (l) | 9.0 |

(f) Hydroxyethyl methacrylate (Aldrich)
(g) Neopentyl Glycol Diacrylate (Sartomer)
(h) Trimethylolpropane Trimethacrylate (Sartomer)

Bis(2,4,6-trimethyl benzoyl) phenyl phosphine oxide (Ciba Geigy) Diphenyl (2,4,6-trimethyl benzoyl) phosphine oxide (BASF) Blocked aliphatic polyisocyanates based on IPDI (isophorone diisocyanate) (Bayer) γ-Aminopropyl triethoxysilane The test lenses were tested for residual bleach color on a Hunter Spectrophotometer and fade rate on an optical bench. Results are tabulated in Table 4.

### EXAMPLE 3

The procedures of Example 2 were followed except that the photochromic polyurethane coating composition contained 0.02 grams of Baysilone PL paint additive (phenyl methyl polysiloxane available from Bayer Corporation). The test lenses were tested for residual bleach color on a Hunter Spectrophotometer and fade rate on an optical bench. Results are tabulated in Table 4.

### EXAMPLE 4

The procedures of Example 2 were followed except that the photochromic polyurethane coating composition was prepared from the components and their amounts tabulated in Table 3. The test lenses were tested for residual bleach color on a Hunter Spectrophotometer and fade rate on an optical bench. Results are tabulated in Table 4.

TABLE 3
Formulation

| Component/ | Amount, Grams |
|---|---|
| Desmodur PL 3175A (a) | 4.1 |
| PC 1122 (c) | 3.5 |
| KP-46-9857 (m) | 0.9 |
| Dibutyltin dilaurate | 0.07 |
| Photochromic Master batch (e) | 3.4 |

Polysiloxane tetrol (Composition of Example 2 of U.S. Pat. No. 6,048,934 B1)

TABLE 4

| Example No. | Initial Bleach Color¹ | T(½)² | TR = 70%³ |
|---|---|---|---|
| 1 | 1.7 | 45 | 5.4 |
| 2 | 2.5 | 53 | 7.1 |
| 3 | 1.7 | 45 | 5.0 |
| 4 | 2.0 | 45 | 5.0 |

¹b* value
²Time in seconds to reach 50% of
³Time in minutes to fade back to 70% light transmission after 15 minute exposure of the lens to a 365 nanometer lamp.

The data of Table 4 shows that there is a significant increase in the residual bleach color (b*) value (residual yellow) for Example 2, vis-à-vis, Example 1, and a significant increase in fade rates for the lenses of Example 2 compared to those of Example 1, as shown by the increase in T(½) and TR=70% values, which increased values indicate that photochromic migration is occurring into the acrylic-based film in Example 2 as compared to Example 1, which has no acrylic based film appended to the photochromic polyurethane coating. In contrast, the addition of a polysiloxane to the photochromic polyurethane coating (Examples 3 and 4) substantially inhibits such migration, as shown by the substantially similar values for residual bleach color (b*) and fade rates for these Examples, as compared to those values for Example 1.

### EXAMPLE 5

The procedures of Example 1 were followed except that the photochromic polyurethane composition was prepared from the components and their amounts listed in Table 5.

TABLE 5
Formulation

| Component/ | Amount, Grams |
|---|---|
| Desmodur PL 3175A (a) | 12.1 |
| PC 1122 (c) | 10.5 |
| HCS 6234 polyol (d) | 3.8 |
| MB-93 Master batch (n) | 12.22 |
| Photochromic Materials(o) | 1.0 |

Prepared by mixing 3.9 grams of Tinuvin 144 hindered amine light stabilizer, 1.42 grams of DBTDL (dibutyl tin dilaurate), 77.11 grams of N-methyl pyrrolidinone and 5.64 grams of A-187 (γ-glycidoxypropyl trimethoxysilane coupling agent).

A mixture of 4 naphthopyran photochromic materials chosen to produce a gray tint when exposed to UV light. The photochromic dyes were pre-dissolved in the MB-93 Master batch and then added to the components of the formulation.

The test lenses were tested for fade rate (TR=70%) on an optical bench. Results are tabulated in Table 6.

### EXAMPLE 6

The procedures of Example 5 were followed except that various amounts of Baysilone PL paint additive were added to 5 grams of the photochromic polyurethane composition and the mixture stirred for 15 minutes before applying the coating to the polycarbonate lenses by spin coating. The coatings were approximately 20 microns thick. Following the procedure of Example 2, the photochromic polyurethane coated lenses were treated with the oxygen plasma and an acrylic-based film applied to the coated lenses. The acrylate-based film was the same as described in Example 2. The test lenses were tested for fade rate (TR=70%) on an optical bench. Results are tabulated in Table 6.

TABLE 6

| Run | Additive | Amount %¹ | TR = 70% (Minutes) |
|---|---|---|---|
| 1 | None | — | 6.5 |
| 2 | Baysilone PL | 0.55 | >20 |
| 3 | Baysilone PL | 1.6 | 6.75 |
| 4 | Baysilone PL | 2.75 | 6.75 |

¹Percent based on Resin Solids

The data of Table 6 shows that a level of 0.55% Baysilone PL in the photochromic polyurethane coating (Run 2) was too low to minimize/inhibit the migration of photochromic materials into the acrylic-based film; but that higher levels of Baysilone PL (Runs 3 and 4) were sufficient to inhibit such migration, as shown by the TR=70% values for Runs 3 and 4, which are comparable to the value for Run 1.

Although the present invention has been described with reference to specific details of certain embodiments thereof, it is not intended that such details should be regarded as limitations upon the scope of the invention exept insofar as they are included in the accompanying claims.

1. In a photochromic article comprising:
(a) a rigid substrate,
(b) a photochromic organic polymeric coating appended to on at least a portion of at least one surface of said substrate, said photochromic coating comprising a photochromic amount of at least one photochromic material, and
(c) a layer chosen from a transparent second organic polymeric coating or an abrasion resistant coating that is superposed on said photochromic polymeric coating, the improvement comprising incorporating at least one polysiloxane surface active agent within the photochromic polymeric coating in amounts sufficient to inhibit migration of photochromic material into said layer that is superposed on said photochromic polymeric coating.

2. The photochromic article of claim 1 wherein the at least one polysiloxane surface active agent (a) has a weight average molecular weight of greater than 250, (b) is dispersible within the curable photochromic polymeric coating superposed on the rigid transparent substrate, and (c) does not significantly adversely affect the optical properties of the photochromic polymeric coating.

3. The photochromic article of claim 1 wherein the at least one polysiloxane surface active agent is a non-reactive polysiloxane and is present in amounts of from 0.6 to 5 weight percent.

4. The photochromic article of claim 1 wherein the at least one polysiloxane surface active agent is a reactive polysiloxane and is present in amounts of from 0.6 to 90 weight percent.

5. The photochromic article of claim 1 wherein the polysiloxane surface active agent is represented by the following general formula,
R¹ ₙR²ₘSiO_{(4-n-m)/2}
wherein each R¹ is chosen from H, OH, a monovalent hydrocarbon group or a monovalent siloxane group; each R² represents a group comprising at least one reactive functional group that forms a covalent bond with another functional group under conditions used to cure the photochromic polymeric coating; and m and n fulfill the requirements of 0<n<4, 0<m<4 and 2≦(m+n)<4.

6. The photochromic article of claim 5 wherein the at least one reactive functional group is chosen from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an onium salt group, an anhydride group, a hydroxy alkylamide group or an epoxy group.

7. The photochromic article of claim 1 wherein the at least one polysiloxane surface active agent is represented by the following formulae, 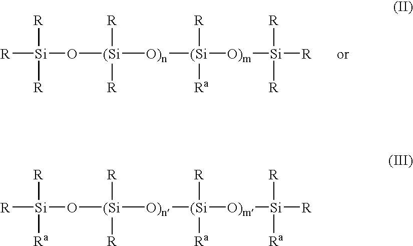
wherein m has a value of at least 1, m′ ranges from 0 to 75, n ranges from 0 to 75, n′ ranges from 0 to 75, each R is chosen from H, OH, a monovalent hydrocarbon group, a monovalent siloxane group or mixtures of the foregoing groups, —R^{a} is represented by the following general formula,
—R³—X (IV)
wherein —R³ is chosen from an alkylene group, an oxyalkylene group, an alkylene aryl group, an alkenylene group, an oxyalkenylene group or an alkenylene aryl group, and X represents a group that comprises at least one reactive functional group chosen from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an onium salt group, an anhydride group, a hydroxy alkylamide group or an epoxy group.

8. The photochromic article of claim 1 wherein the at least one polysiloxane surface active agent is represented by the following formulae, 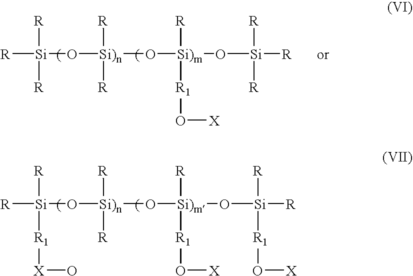
wherein n is 0 to 50; m is at least one; m′ is 0 to 50; R is chosen from OH or monovalent hydrocarbon groups attached to the silicon atoms; R₁ is alkylene, oxyalkylene or alkylene aryl; and X is H, monohydroxy-substituted alkylene, oxyalkylene or —R₂—(CH₂—OH)ₚ wherein p is 2 or 3, and 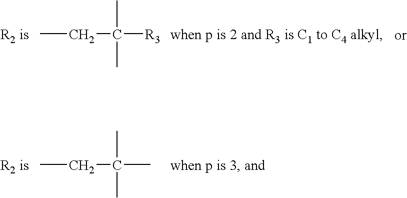
wherein at least a portion of the moiety X is —R₂—(CH₂—OH)ₚ.

9. The photochromic article of claim 8 wherein R₁ is C₃H₆ alkylene.

10. The photochromic article of claim 8 wherein m is 2.

11. The photochromic article of claim 10 wherein p is 2.

12. The photochromic article of claim 7 wherein the values for (n+m) and (n′+m′) range from 2 to 9.

13. The photochromic article of claim 1 wherein the transparent rigid substrate is an organic polymeric substrate chosen from thermoset or thermoplastic materials having a refractive index of from 1.48 to 1.74.

14. The photochromic article of claim 13 wherein the organic polymeric substrate is a substrate chosen from thermoset substrates prepared from polymerizable compositions comprising allyl diglycol carbonate monomer(s), substrates prepared from thermoplastic polycarbonates, substrates prepared from polyurea urethanes or substrates prepared from compositions comprising the reaction product of polyfunctional isocyanate(s) and/or isothiocyanates with polythiol or polyepisulfide monomer(s).

15. The photochromic article of claim 14 wherein the allyl diglycol carbonate is diethylene glycol bis(allyl carbonate).

16. The photochromic article of claim 1 wherein the photochromic organic polymeric coating is chosen from photochromic polyurethane-based coatings, photochromic polyurea urethane-based coatings, photochromic poly(meth)acrylic-based coatings, photochromic aminoplast-based coatings, or photochromic epoxy resin-based coatings.

17. The photochromic article of claim 1 wherein the photochromic material is an organic photochromic material chosen from photochromic spirooxazines, benzopyrans, naphthopyrans, fulgides, metal dithizonates, diarylethenes or mixtures of such photochromic materials.

18. The photochromic article of claim 17 wherein the photochromic naphthopyran is chosen from naphtho[1,2-b]pyrans, naphtho[2,1-b]pyrans, spiro-9-fluoreno[1,2-b]pyrans, phenanthropyrans, quinopyrans or indeno-fused naphthopyrans, and the spirooxazine is chosen from naphthoxazines or spiro (indoline)pyridobenzoxazines.

19. The photochromic article of claim 1 wherein said layer (c) is a transparent second organic polymeric coating and an abrasion resistant coating is appended to said second organic polymeric coating.

20. The photochromic article of claim 19 wherein an antireflective coating is appended to said abrasion resistant coating.

21. The photochromic article of claim 20 wherein the photochromic article is a lens.

22. In a photochromic article comprising:
(a) a rigid transparent substrate,
(b) a photochromic organic polymeric coating appended to at least a portion of said substrate, said photochromic coating comprising a photochromic amount of at least one organic photochromic material, and
(c) a layer chosen from a transparent second organic polymeric coating or an abrasion resistant coating that is appended to said photochromic polymeric coating, the improvement comprising incorporating at least one polysiloxane surface active agent within the photochromic polymeric coating in amounts sufficient to inhibit migration of photochromic material into said layer that is appended to said photochromic polymeric coating.

23. The photochromic article of claim 22 wherein the at least one polysiloxane surface active agent (a) has a weight average molecular weight of greater than 250, (b) is dispersible within the curable photochromic polymeric coating applied to the rigid transparent substrate, and (c) does not significantly adversely affect the optical properties of the photochromic polymeric coating.

24. The photochromic article of claim 23 wherein the at least one polysiloxane surface active agent is chosen from (a) non-reactive polysiloxanes, which are present in amounts of from 0.6 to 2 weight percent, (b) reactive polysiloxanes, which are present in amounts of from 1 to 50 weight percent, or (c) mixtures of such polysiloxane surface active agents.

25. The photochromic article of claim 24 wherein the polysiloxane surface active agent is represented by the following general formula,
R¹ₙR²ₘSiO_{(4-n-m)/2}
wherein each R¹ is chosen from H, OH, a monovalent hydrocarbon group or a monovalent siloxane group; each R² represents a group comprising at least one reactive functional group that forms a covalent bond with another functional group under conditions used to cure the photochromic polymeric coating; m and n fulfill the requirements of 0<n<4, 0<m<4 and 2≦(m+n)<4; and wherein the at least one reactive functional group is chosen from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an onium salt group, an anhydride group, a hydroxy alkylamide group or an epoxy group.

26. The photochromic article of claim 24 wherein the at least one polysiloxane surface active agent is represented by the following formulae, 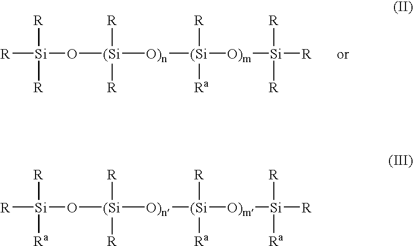
wherein m has a value of at least 1, m′ ranges from 0 to 75, n ranges from 0 to 75, n′ ranges from 0 to 75, each R is chosen from H, OH, a monovalent hydrocarbon group, a monovalent siloxane group or mixtures of the foregoing groups, —R^{a} is represented by the following general formula,
—R³—X (IV)
wherein —R³ is chosen from an alkylene group, an oxyalkylene group, an alkylene aryl group, an alkenylene group, an oxyalkenylene group or an alkenylene aryl group, and X represents a group that comprises at least one reactive functional group chosen from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an onium salt group, an anhydride group, a hydroxy alkylamide group or an epoxy group.

27. The photochromic article of claim 26 wherein the values for (n+m) and (n′+m′) range from 2 to 9.

28. The photochromic article of claim 24 wherein the at least one polysiloxane surface active agent is represented by the following formulae, 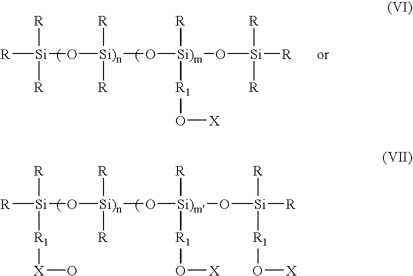
wherein n is 0 to 50; m is at least one; m′ is 0 to 50; R is chosen from OH or monovalent hydrocarbon groups attached to the silicon atoms; R₁ is alkylene, oxyalkylene or alkylene aryl; and X is H, monohydroxy-substituted alkylene, oxyalkylene or —R₂—(CH₂—OH)ₚ wherein p is 2 or 3, and 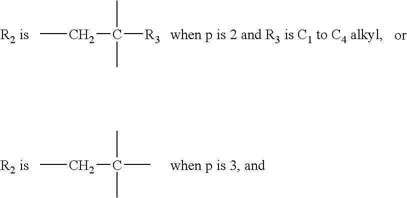
wherein at least a portion of the moiety X is —R₂—(CH₂—OH)ₚ.

29. The photochromic article of claim 28 wherein R₁ is C₃H₆ alkylene.

30. The photochromic article of claim 28 wherein m is 2.

31. The photochromic article of claim 30 wherein p is 2.

32. The photochromic article of claim 24 wherein said layer (c) is a transparent second organic polymeric coating and an abrasion resistant coating is appended to said second organic polymeric coating.

33. In a photochromic article comprising:
(a) a rigid transparent substrate, said substrate being an organic polymeric substrate chosen from thermoset or thermoplastic materials having a refractive index of from 1.48 to 1.74,
(b) a photochromic organic polymeric coating appended to at least a portion of said substrate, said photochromic coating comprising a photochromic amount of at least one organic photochromic material, and
(c) a layer comprising a transparent second organic polymeric coating that is appended to said photochromic polymeric coating, the improvement comprising incorporating at least one polysiloxane surface active agent within the photochromic polymeric coating in amounts sufficient to inhibit migration of photochromic material into said layer that is appended to said photochromic polymeric coating.

34. The photochromic article of claim 33 wherein the polysiloxane surface active agent is represented by the following general formula,
R¹ₙR²ₘSiO_{(4-n-m)/2}
wherein each R¹ is chosen from H, OH, a monovalent hydrocarbon group or a monovalent siloxane group; each R² represents a group comprising at least one reactive functional group that forms a covalent bond with another functional group under conditions used to cure the photochromic polymeric coating; m and n fulfill the requirements of 0<n<4, 0<m<4 and 2≦(m+n)<4; and wherein the at least one reactive functional group is chosen from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an onium salt group, an anhydride group, a hydroxy alkylamide group or an epoxy group.

35. The photochromic article of claim 34 wherein the organic polymeric substrate is a substrate chosen from thermoset substrates prepared from polymerizable compositions comprising allyl diglycol carbonate monomer(s), substrates prepared from thermoplastic polycarbonates, substrates prepared from polyurea urethanes or substrates prepared from compositions comprising the reaction product of polyfunctional isocyanate(s) and/or isothiocyanate(s) with polythiol or polyepisulfide monomer(s).

36. The photochromic article of claim 35 wherein the photochromic organic polymeric coating is chosen from photochromic polyurethane-based coatings, photochromic polyurea urethane-based coatings, photochromic poly(meth)acrylic-based coatings, photochromic aminoplast resin-based coatings, or photochromic epoxy resin-based coatings.

37. The photochromic article of claim 33 wherein the at least one polysiloxane surface active agent is represented by the following formulae, 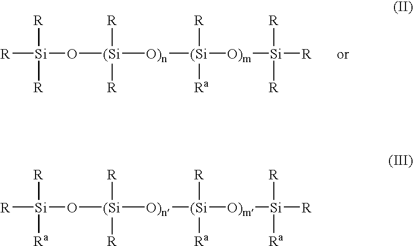
wherein m has a value of at least 1, m′ ranges from 0 to 75, n ranges from 0 to 75, n′ ranges from 0 to 75, each R is chosen from H, OH, a monovalent hydrocarbon group, a monovalent siloxane group or mixtures of the foregoing groups, —R^{a} is represented by the following general formula,
—R³—X (IV)
wherein —R³ is chosen from an alkylene group, an oxyalkylene group, an alkylene aryl group, an alkenylene group, an oxyalkenylene group or an alkenylene aryl group, and X represents a group that comprises at least one reactive functional group chosen from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an onium salt group, an anhydride group, a hydroxy alkylamide group or an epoxy group.

38. The photochromic article of claim 37 wherein the organic polymeric substrate is a substrate chosen from thermoset substrates prepared from polymerizable compositions comprising allyl diglycol carbonate monomer(s), substrates prepared from thermoplastic polycarbonates, substrates prepared from polyurea urethanes or substrates prepared from compositions comprising the reaction product of polyfunctional isocyanate(s) and/or isothiocyanate(s) with polythiol or polyepisulfide monomer(s).

39. The photochromic article of claim 38 wherein the photochromic organic polymeric coating is chosen from photochromic polyurethane-based coatings, photochromic polyurea urethane-based coatings, photochromic poly(meth)acrylic-based coatings, photochromic aminoplast resin-based coatings, and photochromic epoxy resin-based coatings.

40. The photochromic article of claim 33 wherein the at least one polysiloxane surface active agent is represented by the following formulae, 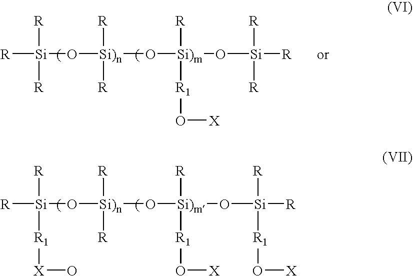
wherein n is 0 to 50; m is at least one; m′ is 0 to 50; R is chosen from OH or monovalent hydrocarbon groups attached to the silicon atoms; R₁ is alkylene, oxyalkylene or alkylene aryl; and X is H, monohydroxy-substituted alkylene, oxyalkylene or —R₂—(CH₂—OH)ₚ wherein p is 2 or 3, and 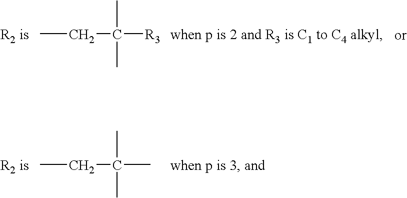
wherein at least a portion of the moiety X is —R₂—(CH₂—OH)ₚ.

41. The photochromic article of claim 40 wherein the organic polymeric substrate is a substrate chosen from thermoset substrates prepared from polymerizable compositions comprising allyl diglycol carbonate monomer(s), substrates prepared from thermoplastic polycarbonates, substrates prepared from polyurea urethanes or substrates prepared from compositions comprising the reaction product of polyfunctional isocyanate(s) and/or isothiocyanate(s) with polythiol or polyepisulfide monomer(s).

42. The photochromic article of claim 41 wherein the photochromic organic polymeric coating is chosen from photochromic polyurethane-based coatings, photochromic polyurea urethane-based coatings, photochromic poly(meth)acrylic-based coatings, photochromic aminoplast resin-based coatings, and photochromic epoxy resin-based coatings.

43. The photochromic article of claim 33 wherein less than 5 weight percent of particles chosen from inorganic particles, composite particles or mixtures of such particles are incorporated into the photochromic organic polymeric coating, said particles having an average particle size of from 5 to 50 nanometers prior to being incorporated into said photochromic coating and when so incorporated into the photochromic coating do not significantly adversely affect the optical properties of the photochromic coating.

44. The photochromic article of claim 33 wherein the transparent second organic polymeric layer (c) is a radiation cured acrylic-based polymer, dendritic polyester acrylate-based polymer.

45. The photochromic article of claim 44 wherein an abrasion resistant coating is appended to the transparent second organic polymeric layer (c).

46. The photochromic article of claim 45 wherein the abrasion resistant coating is an organo silane-based abrasion resistant coating.

47. The photochromic article of claim 45 wherein an antireflective coating is appended to the abrasion resistant coating.

48. The photochromic article of claim 42 wherein the transparent second organic polymeric layer (c) is a radiation cured acrylic-based polymer.

49. The photochromic article of claim 48 wherein an abrasion resistant coating is appended to the transparent second organic polymeric layer (c).

50. The photochromic article of claim 49 wherein an antireflective coating is appended to the abrasion resistant coating.

51. The photochromic article of claim 50 wherein the article is a lens.

52. In a photochromic article comprising:
(a) a rigid substrate, and
(b) a photochromic organic polymeric coating appended to at least a portion of at least one surface of said substrate, said photochromic coating comprising a photochromic amount of at least one photochromic material, the improvement which comprises incorporating a migration inhibiting amount of at least one polysiloxane surface active agent within the photochromic polymeric coating.
